(19) United States
(12) Patent Application Publication
(10) Pub. No.: US 2009/0041173 A1
(43) Pub. Date: Feb. 12, 2009

(54) DATA CLOCK RECOVERY SYSTEM USING DIGITAL ARRIVAL-TIME DETECTOR

(76) Inventor: Wen T. Lin, Ambler, PA (US)

Correspondence Address: FOX ROTHSCHILD LLP, P O BOX 592, 112 NASSAU STREET, PRINCETON, NJ, 08542-0592, US

(21) Appl. No.: 12/093,662

(22) PCT Filed: Nov. 14, 2006
(86) PCT No.: PCT/US2006/060877

§ 371 Date: Aug. 22, 2008

Related U.S. Application Data
(60) Provisional application No. 60/736,476, filed on Nov. 14, 2005.
(60) Provisional application No. 60/806,639, filed on Jul. 6, 2006.

(51) Int. Cl. H04L 7/00

(52) U.S. Cl. 375/374

(57) ABSTRACT

This patent disclosure presents circuits, systems and methods to extract the clock signal from a data stream. This new invention is far better than the current technologies in the range of frequency locking and tracking. Since the new data clock recovery system is built by digital circuits only, it can be implemented inside an IC easily. This invention is especially helpful for high speed data communication products since the clock can be recovered at full data rate.

### CROSS REFERENCE TO APPLICATIONS

This application is related to, and claims priority from U.S. Provisional Application No. 60/736,476, filed Nov. 14, 2005, and U.S. Provisional Application No. 60/806,639, filed Jul. 6, 2006, and is also related to International Application No. PCT/US2005/026842, filed Jul. 28, 2005, and International Application No. PCT/US2006/017856, filed May 4, 2006.

### TECHNICAL FIELD

The present invention relates to the field of digital signal processing, and more specifically, the present invention relates to a method, apparatus, and system for improved data clock recovery system used in the digital communication systems.

### BACKGROUND ART

The data clock recovery system is usually the most difficult part of a digital communication system. In order for two digital devices to communicate with each other without error, ideally, a data channel and a clock channel are both needed. The data channel contains only the data to be sent to the receiving end while the clock channel contains only the clock signal for the receiving end to clock out the data sent in the data channel. With a reliable clock signal sent separately from the transmitting end, the receiving end can clock out the received data with a good confidence. Unfortunately, the luxury of an extra clock channel is not always available in most applications because it doubles the costs of communications. As a result, most digital communication devices require a data clock recovery circuit at the receiving end to recover the clock signal from the same streaming data signal in the data channel.

Since the data does not need to have a transient for every clock period, the traditional digital phase frequency detector (PFD) which can synchronize both the frequency and phase of the feedback signal generated from a local voltage control oscillator (VCO) to an incoming reference signal over a large range of frequency and phase uncertainty is useless because it requires a stable clock transient edge in every comparison cycle from both the reference input signal and feedback signal from the VCO. Missing a single clock transient edge is interpreted by the PFD as reducing the clock frequency by half. As a result, most of the current data clock recovery technologies have to use an analog phase locked loop (PLL) with a linear phase detector to synchronize the feedback signal generated from the local VCO to the incoming data stream even though the analog PLL is notorious for having a small capture range of frequency. To overcome the problem of small frequency capture range, a secondary frequency locked loop (FLL) is usually needed to acquire the frequency of the incoming data stream for the analog PLL.

The traditional data clock recovery system 200 can be shown as in FIG. 1. In this design, a linear frequency locked loop (FLL) including a frequency detector 102, loop filter 106 and VCO 108 and an analog phase locked loop (PLL) including a linear analog phase detector 101, loop filter 106 and VCO 108 are combined together to lock the frequency and phase of the feedback signal 112 from VCO 108 to the incoming data input stream 110. The analog PLL with an analog linear phase detector 101 alone is usually unable to perform the data clock recovery all by itself because it has a very small frequency capture range and the analog PLL using an analog linear phase detector 101 usually has many stable operating points at different frequencies so that the analog PLL can lock in at a wrong frequency to cause false-locking easily. The FLL can prevent the false-locking problem of the analog PLL by providing a coarse tuning to steer the frequency of feedback signal 112 from the VCO 108 to be near the desired frequency of the input data stream 110 first. Once the FLL steers the frequency of the feedback signal 112 from VCO 108 to be near the frequency of input data stream 110, the frequency detector 102 is then retired and the analog PLL using an analog linear phase detector 101 will take over to continue to track the frequency and phase of the feedback signal 112 from VCO 108 until both the phase and the frequency of the feedback signal 112 from VCO is locked to the phase and the frequency of the input data stream 110. The U.S. Pat. No. 4,590,602 illustrated a typical data clock recovery system utilizing both the PLL and FLL as described above.

Most of the current analog linear phase detectors 101 used in the analog PLL of the data clock recovery are Exclusive-OR gate type analog linear phase detector which has a very small capture range for the frequency so that it needs an FLL as the coarse tuning to acquire the frequency first before the linear PLL can track and correct the frequency and phase error. Even worse, since the output of Exclusive-Or gate can be affected by the variation of duty cycle of the input data stream 110, the variations of duty cycle in the input data stream 110 become errors in the VCO correction signal and can affect both the locking and tracking range of the PLL significantly. To overcome the difficulties with the analog PLL, a special kind of digital PLL technology using over-sampling technique became very popular for the data clock recovery systems such as shown in the U.S. Pat. No. 6,100,765. In the digital PLL technology, a state machine is used to adjust the frequency and phase of the feedback signal 112 from VCO 108 constantly to track the frequency and phase of the incoming data stream 110. This kind of digital PLL technology has a much larger capture and tracking range than the analog PLL technology; however, the data rate it can handle is only a fraction of what the device is capable of due to the over-sampling requirement.

A new circuit and system for the data clock recovery that is completely digital design suitable for IC implementation and can track the frequency and phase of the input data stream over a large range of phase and frequency uncertainty at the maximum full data rate is thus very desirable.

### DISCLOSURE OF NEW INVENTIONS

The present invention provides a system, a method and apparatus for locking the arrival of the feedback signal 112 generated from a local voltage controlled oscillator (VCO) 108 to the arrival of an incoming data stream 110 from a communication channel that the arrival edge of the incoming data stream 110 from the communication channel might not be present in every clock period of the data stream 110.

In the preferred embodiment 182 of the data clock recovery loop as shown in FIG. 20, the arrival edges of the incoming data stream 110 from a communication channel are compared with the arrival edges of the feedback signal 112 generated from the local VCO 108 by two digital arrival-time detectors, namely the even clock digital arrival-time detector (190, 194, 206) and the odd clock digital arrival-time detector (192, 196 and 208). The even and odd digital arrival-time detectors will take turns to produce an arrival-time error correction output 114 to correct the VCO 108 alternatively according to the arrival sequence and the arrival-time difference between the two input signals. The two digital arrival-time detectors will produce a positive error output 114 to speed up the arrival of the feedback signal 112 from VCO when the arrival edge of the feedback signal 112 from VCO is behind the arrival edge of the incoming data stream 110 or a negative error output 114 to slow down the arrival of the feedback signal 112 from VCO when the arrival edge of the feedback signal 112 from VCO is ahead of the arrival edge of the incoming data stream 110 or a net zero error output 114 to maintain the same arrival rate of the feedback signal 112 from VCO when the arrival edge of the incoming data stream is absent so that there is no arrival edge from the data input stream 110 for the feedback signal 112 from VCO to compare with.

An arrival-time comparison cycle 156 of the data clock recovery loop 182 is made of two clock periods of the feedback signal 112 from VCO. The two clock periods of the feedback signal 112 from VCO are the arrival-time correction period 150 and the arrival-time compensation period 152. The two digital arrival-time detectors will stay in the arrival-time correction period 150 and the arrival-time compensation period 152 alternatively so that when one of the digital arrival-time detectors is in the arrival-time correction period 150, the other one of the digital arrival-time detectors will be in the arrival-time compensation period 152. When either one of the two digital arrival-time detectors is in the arrival-time correction period 150, this digital arrival-time detector will be producing an arrival-time error output signal 114 according to the arrival sequence and arrival-time difference between the two input signals to correct the arrival-time of the feedback signal 112 from VCO 108 while the other one of the digital arrival-time detectors will be in the arrival-time compensation period 152. In the arrival-time compensation period 152, the digital arrival-time detector is in the reset condition so that the arrival sequence and arrival-time difference between the two input signals to the digital arrival-time detector does not produce any arrival-time error correction output 114 to correct the arrival-time of the feedback signal 112 from VCO 108; however, the charge pump output of the digital arrival-time detector, depending upon whether if the arrival edge of the input data stream 110 was absent or present in the last arrival-time correction period 150, may produce an output to affect the arrival-time of the feedback signal 112 from VCO 108 during the current arrival-time compensation period 152. If the arrival edge of the input data stream 110 was missing in the last arrival-time correction period 150, the digital arrival-time detector would have made a mistake to have corrected the VCO by pulling down the final correction output voltage 115 to the VCO for approximately half the period of the feedback signal 112 from VCO when the digital arrival-time detector was in the last arrival-time correction period 150 so that, in the current arrival-time compensation period 152, the final error correction output voltage 115 to the VCO 108 should be compensated for by the same amount of correction as the erroneous correction that has occurred during the last arrival-time correction period 150 and the arrival rate of the feedback signal 112 from VCO should be restored to the same arrival rate before the erroneous corrections occurred during the last arrival-time correction period 150. If the arrival edge of the input data stream 110 was present in the last arrival-time correction period 150, then the final error correction output voltage 115 to the VCO 108 should not be compensated at all during the current arrival-time compensation period 152.

As a result, this new design of data clock recovery loop 182 can correct the arrival-time error of the feedback signal 112 from VCO no matter whether if the arrival edge of the input data stream 110 is present or absent. The new data clock recovery loop 182 can thus lock the arrival-time of the feedback signal 112 generated from the VCO 108 to the arrival-time of incoming data stream 110 with a large frequency capture range at the full data rate and the operation of the data clock recovery loop 182 is insensitive to the duty cycle variation of the input data stream 110.

These and other features of the present invention will now be described in detail by reference to the following drawings

### BRIEF DESCRIPTION OF DRAWINGS

FIG. 1 is the block diagram of the traditional data clock recovery system (prior art).

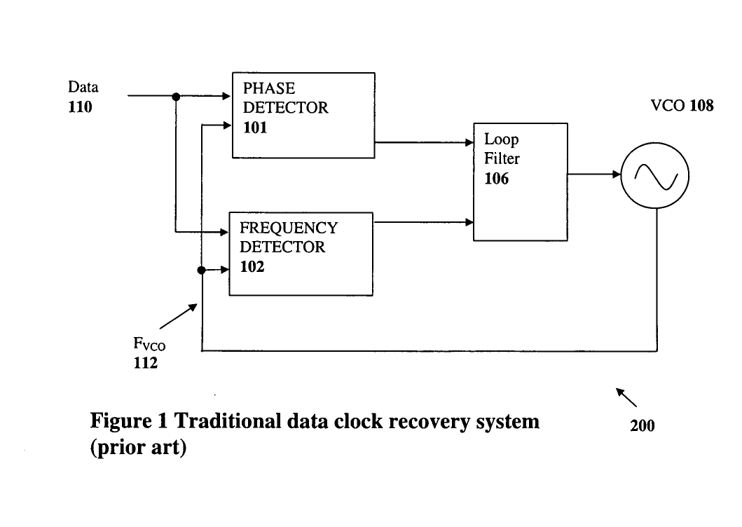

FIG. 2 is the block diagram of the linear arrival-time locked loop.

FIG. 3 shows the schematics of a typical digital arrival-time detector.

FIG. 4 is the schematics of a basic phase frequency detector driving a double-ended charge pump output (prior art).

FIG. 5 shows the timing diagram of the basic PFD as shown in FIG. 4. (prior art).

FIG. 6 is the schematics of a simplified digital arrival-time detector as the first embodiment.

FIG. 7 shows the timing diagram of the simplified digital arrival-time detector as shown in FIG. 6.

FIG. 8 is the schematics of a digital arrival-time detector that uses only the sinking charge pump output driver as the second embodiment.

FIG. 9 shows the transfer characteristics of the digital arrival-time detector using only the sinking charge pump output driver as shown in FIG. 8.

FIG. 10 is the schematics of a digital arrival-time detector that uses only the sourcing charge pump output driver as the third embodiment.

FIG. 11 is the transfer characteristics of the digital arrival-time detector using only the sourcing charge pump output driver as shown in FIG. 10.

FIG. 12 shows the timing diagram of even enable clock and odd enable clock for the data clock recovery system.

FIG. 13 shows the block diagram of the complete data clock detector using two digital arrival-time detectors as the fourth embodiment.

FIG. 14 is the schematics for the VCO arrival-time detector.

FIG. 15 is the schematics for the Data arrival-time detector.

FIG. 16 is the schematics of even digital arrival-time detector as the fifth embodiment.

FIG. 17 is the schematics of the simplified even digital arrival-time detector as the sixth embodiment.

FIG. 18 is the schematics of the Odd digital arrival-time detector.

FIG. 19 is the schematics of the simplified Odd digital arrival-time detector.

FIG. 20 is the block diagram of a data clock recovery loop using two digital arrival-time detectors as the preferred embodiment.

FIG. 21 is the schematics of the digital arrival-time detector with a dead zone that uses only the sourcing charge pump output driver as the first alternate embodiment.

FIG. 22 is the schematics of the digital arrival-time detector with a dead zone that uses only the sinking charge pump output driver as the second alternate embodiment.

FIG. 23 is the schematics of the simplified ODD digital arrival-time detector with a dead zone as the third alternate embodiment.

FIG. 24 is the schematics of the simplified Even digital arrival-time detector with a dead zone.

FIG. 25 is the transfer characteristics of the digital arrival-time detector with a dead zone using only the sourcing charge pump output driver.

FIG. 26 is the transfer characteristics of the digital arrival-time detector with a dead zone using only the sinking charge pump output driver.

FIG. 27 is the block diagram of a data clock recovery loop using a single digital arrival-time detector as the fourth alternate embodiment.

### BEST METHOD FOR CARRYING OUT THE INVENTION

The concept of arrival-time was introduced after the invention of radar during World War II to solve the uncertainty nature of the arrival of signal. The arrival of a signal can be characterized as a stochastic process and the arrival-time of the signal is a function of the amplitude, frequency and phase of the signal. The characteristics of the arrival-time of the signal can thus be regarded as the fourth variable of a signal. A traditional signal can be represented by three variables, phase, frequency and amplitude to characterize the deterministic nature of the signal and the arrival-time is the fourth variable of the signal that characterizes the stochastic nature of the signal.

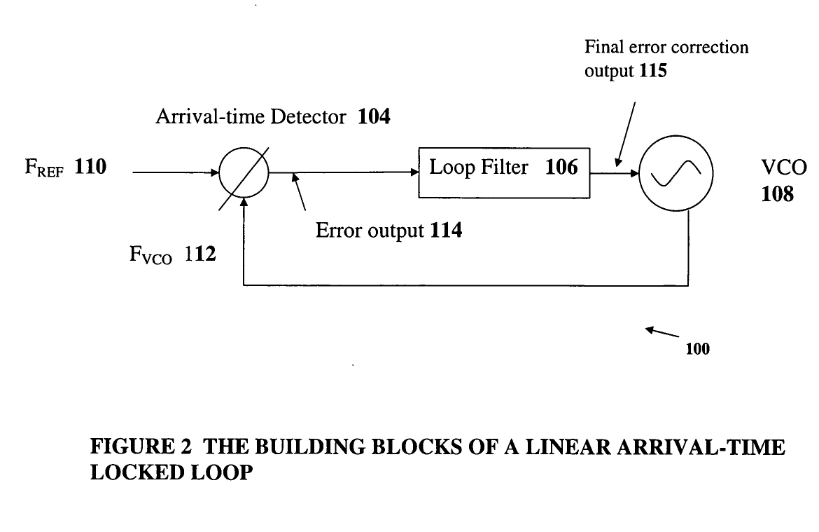

An arrival-time locked loop 100 as shown in FIG. 2 can synchronize the arrival of local feedback signal 112 generated from the VCO 108 to the arrival of a reference input signal 110 so that both signals arrive at the arrival-time detector 104 at the same time all the time. The best way to understand the arrival-time locked loop is to exam the arrival-time locked loop 100 that uses a frequency mixer as the arrival-time detector 104. As explained in great detail in PCT Application No. PCT/US2005/026842, “A system and method to detect the difference of a phase, a frequency and an arrival-time difference between two signals” filed on Jul. 28, 2005, by Wen T. Lin and PCT Application No. PCT/US2006/017856, “Arrival-time Locked Loop” filed on May 4, 2006 by Wen T. Lin, the arrival-time locked loop 100 using a frequency mixer as the arrival-time detector 104 produces a final error correction output 115 to the VCO that is equal to

V(final error correction)=Km*Vref*Vvco*SIN((ωref−ωvco)t+θref−θvco) equ. 1

where km is the gain of the frequency mixer and Vref, ωref, θref are the amplitude, frequency and phase of the reference input signal 110 accordingly and Vvco, ωvco, θvco are the amplitude, frequency and phase of the feedback signal 112 accordingly.

It is clear from equation 1 that the final error correction output 115 to the VCO generated from the arrival-time detector 104 of the arrival-time locked loop 100 is a function of the amplitude, frequency and phase of the two input signals to the arrival-time detector 104 so that the feedback signal 112 from VCO will be corrected according to the arrival-time difference between the two input signals to the arrival-time detector 104. The arrival-time locked loop 100 will continue to correct the VCO until when both input signals to the arrival-time detector 104 always arrives at the same time so that the error output 114 is zero all the time since the arrival of feedback signal 112 from VCO is locked to the arrival of reference input signal 110 at the input of arrival-time detector 104 and no more correction to VCO is needed.

For a typical arrival-time locked loop 100 with a digital arrival-time detector 104 as the error detector, the digital arrival-time detector 104 compares each arrival of the feedback signal 112 generated from the local VCO 108 with each arrival of the reference input signal 110 to produce an error output signal 114 to correct the VCO 108 according to the arrival sequence and arrival-time difference between the two input signals for every arrival-time comparison cycle. An arrival-time comparison cycle is made of an arrival edge from each of the two input signals. The arrival-time comparison cycle begins when the first arrival signal arrives and it ends when the late arrival signal arrives. The digital arrival-time detector 104 will enable the error output signal 114 shortly after the arrival of the early arrival signal. The polarity of the error output signal 114 will be positive when the reference input signal 110 arrives earlier and the polarity of the error output signal 114 will be negative when the feedback signal 112 from VCO arrives earlier. The enabling of the error output signal 114 will be disabled shortly after the arrival of the late arrival signal so that the duration of the period when the error output signal 114 is enabled is determined by the arrival-time difference between the two input signals. After the arrival of the late arrival signal, the digital arrival-time detector 104 will be reset and is ready for the next arrival-time comparison cycle to begin. As a result, the polarity of the error output signal 114 is determined by the arrival sequence of the two input signals and the duration of the error output signal 114 is determined by the arrival-time difference between the two input signals. Since the error output signal 114 will be integrated by the loop filter 106 to become the final error correction output 115 to correct the VCO, the polarity of final error correction output 115 is determined by the arrival sequence of the two input signals and the amplitude of the final error correction output 115 is determined by the arrival-time difference between two input signals. As a result, the arrival of the feedback signal 112 from VCO will be corrected according to the arrival sequence and arrival-time difference between the two input signals linearly. If the arrival of feedback signal 112 from VCO is behind the arrival of reference input signal 110 by a large amount, the feedback signal 112 from VCO will be sped up by a large positive final error correction output 115; if the arrival of feedback signal 112 from VCO is ahead of the arrival of reference input signal 110 by a small amount, the feedback signal 112 from VCO will be slowed down by a small negative final error correction output 115 so that the arrival-time difference between the two input signals will become smaller all the time until eventually the arrival-time difference between the two input signals becomes zero and the error output signal 114 becomes zero. Ideally, the arrival-time difference will remain zero forever afterward since the arrival of feedback signal 112 from VCO is locked to the arrival of the reference input signal 110 and no further correction to the VCO is needed. So that both the analog and digital arrival time detector 104 can lock the arrival of the feedback signal 112 generated from the local VCO to the arrival of the reference input signal 110 precisely for an arrival-time locked loop 100.

The arrival-time locked loop 100 is made of three building blocks, the arrival-time detector 104, the loop filter 106 and a VCO 108. The arrival-time detector 104 is a linear device with two input signals and an output. The arrival-time detector 104 can produce an error output signal 114 with the polarity of the error output signal 114 determined by the arrival sequence of the two input signals and the duration of the error output signal 114 determined by the arrival-time difference between the two input signals. The error correction output signals 114 becomes the final error correction output 115 to correct the VCO after the error correction output signal 114 is filtered by the loop filter 106 to remove undesired digital noises to become a clean final error correction output 115 to correct the VCO 108 according to the arrival sequence and arrival-time difference between the reference input signal 110 and the local feedback signal 112 generated from the VCO 108. When the reference input signal 110 arrives at the arrival-time detector 104 earlier than the feedback signal 112 from VCO, a positive final error correction output 115 produced from the arrival-time detector 104 will speed up the arrival of the feedback signal 112 from VCO and when the reference input signal 110 arrives at the arrival-time detector 104 later than the feedback signal 112 from VCO, a negative final error correction output 115 produced from the arrival-time detector 104 will slow down the arrival of the feedback signal 112 from VCO. Since the amount of final error correction output signal 115 produced from the arrival-time detector 104 to correct the VCO is produced according to the amount of arrival-time difference between the reference input signal 110 and the feedback signal 112 from VCO linearly, the feedback signal 112 from VCO will be sped up or slowed down linearly according to arrival-time difference between the reference input signal 110 and the feedback signal 112 from VCO. As the arrival-time locked loop 100 continues to correct the arrival of the feedback signal 112 from VCO, the arrival-time difference between the reference input signal 110 and the feedback signal 112 from VCO will become smaller and smaller. The arrival-time locked loop 100 will continue to correct the arrival of the feedback signal 112 from VCO until eventually the feedback signal 112 from VCO always arrives at the arrival-time detector 104 at the same time as the reference input signal 110 and the error output signal 114 becomes zero. When both the feedback signal 112 from VCO and the reference input signal 110 arrive at the arrival-time detector 104 at the same time, the error output signal 114 will become zero so that the VCO will not be corrected any more since the arrival of feedback signal 112 from VCO is now synchronized to the arrival of reference input signal 110. The arrival-time locked loop 100 is thus a feedback control loop capable of synchronize the arrival of a local feedback signal 112 generated from a VCO to the arrival of a reference input signal 110 precisely.

The key component of the arrival-time locked loop 100 is the arrival-time detector 104. There are many kinds of arrival-time detector 104 that can be used in the arrival-time locked loop 100 as presented in PCT/US2005/026842 “A system and method to detect the difference of a phase, a frequency and an arrival-time difference between two signals” filed on Jul. 28, 2005 by Wen T. Lin and PCT/US2006/017856 “Arrival-time Locked Loop” filed on May 4, 2006 by Wen T. Lin. However, for these arrival-time detectors 104 to work properly, both the reference input signal 110 and the feedback signal 112 from VCO must have an arrival edge for every clock period of the signal constantly so that both of the arrival of the reference input signal 110 and the arrival of feedback signal 112 from VCO occur regularly within a predictable time interval and there are always two arrival edges in every arrival-time comparison cycle, one from the reference input signal 110 and one from the feedback signal 112 from VCO, for the arrival-time detector 104 to produce an error output signal 114 according to the arrival sequence and arrival-time difference between the two input signals to correct the VCO. When the arrival edge from either one of the two input signals is missing unexpectedly, the arrival-time detector 104 will correct the feedback signal 112 from VCO by a maximum amount because the arrival-time detector 104 interprets the loss of an arrival edge of the input signal as halving the frequency of the input signal so that a large amount of error output correction 114 to the arrival-time of the feedback signal 112 from VCO is necessary. As a result, we can not use a typical arrival-time detector 104 as shown in the above two PCT patent applications directly for the application of data clock recovery by simply replacing the reference input signal 110 with the incoming data stream 110 from the communication channel because the arrival edge of the incoming data stream from a communication channel can be absent. As a result, we need to modify the typical arrival-time detector 104 and to find a way to compensate for the erroneous correction to the feedback signal 112 from VCO due to the absence of arrival edge in the incoming data stream 110. In a conclusion, the operation of an ideal data clock recovery system 182 must obey the following three rules in each and every arrival-time comparison cycle.
1. To slow down the arrival of the feedback signal 112 from VCO 108 when the arrival of input data stream 110 is behind the arrival of feedback signal 112 from the VCO 108. The amount of VCO correction executed should be proportional to the arrival-time difference between the feedback signal 112 from the VCO and the input data stream 110.
2. To speed up the arrival of the feedback signal 112 from VCO 108 when the arrival of input data stream 110 is ahead of the arrival of feedback signal 112 from the VCO 108. The amount of VCO correction executed should be proportional to the arrival-time difference between the feedback signal 112 from the VCO and the input data stream 110.
3. Maintain the same arrival rate for the feedbacks signal 112 from VCO 108 when there is no arrival edge in the input data stream 110 for the feedback signal 112 to compare with.

An ideal data clock recovery system operated according to the above three rules will be able to correct the arrival-time error of the feedback signal 112 generated from the local VCO 108 to the arrival of the data input stream 110 over a large frequency range as long as the frequency of the incoming data stream 110 does not exceed the operating frequency range of the VCO 108. Since the first two rules of the above algorithm are also used in a linear arrival-time locked loop 100 with a digital arrival-time detector 104, we can produce an ideal data clock recovery system by incorporating the third rule into the existing linear arrival-time locked loop 100.

The linear arrival-time locked loop 100 was invented to solve the dead zone jittering problem of the current phase locked loop technology. The dead zone jittering problem was explained in great detail in the two PCT patent applications, PCT/US05/26842 filed on Jul. 28, 2005, “A system, method and circuit to detect a phase, a frequency and an arrival-time difference between two signals.” by Wen T. Lin and PCT/US/2006/17856 filed on May 4, 2006, “Arrival-time locked loop” also by Wen T. Lin. From these two patent applications, it is now known that the concept of phase locked was simply a mistake due to over-simplification and the concept of arrival-time can finally solve the dead-zone jittering problem once and for all.

There are three kinds of arrival-time detectors 104. The first kind of arrival-time detector is the analog arrival-time detector such as a frequency mixer or an EXOR gate. The analog arrival-time detector usually produces a small gain and has a severe limit of the capture range for frequency so that it is difficult to use. The second kind of arrival-time detector is the erroneous digital arrival-time detector that produces a dead zone jittering glitch, such as the traditional PFD. And the last kind of the arrival-time detector is the new digital arrival-time detectors that are completely accurate, precise and free of dead-zone jitter as illustrated in the above two PCT applications and in this disclosure. Since the new digital arrival-time detectors are the only breed of arrival-time detector capable of locking the arrival of feedback signal 112 from VCO to the arrival of the incoming reference input signal 110 with a large frequency capture range without dead-zone jittering, we will only use them for the data clock recovery system.

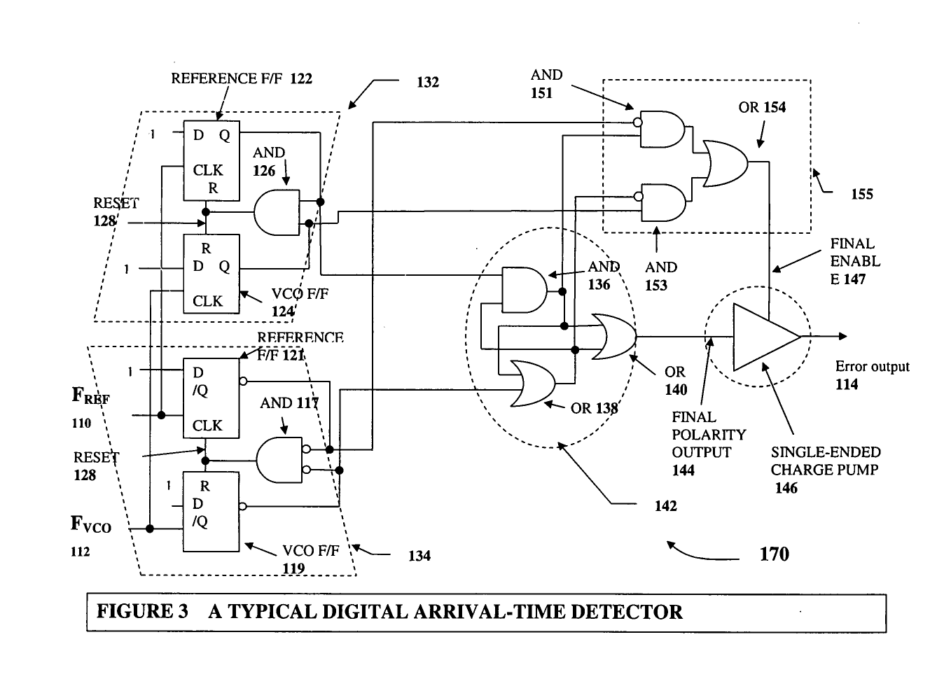

The heart of the digital arrival-time detector is the polarity selection circuit 142 as shown in FIG. 3 which is the schematic diagram for a typical digital arrival-time detector 170. It is the polarity selection circuit 142 that makes the digital arrival-time detector 170 different from the traditional PFD 132. The principle of the digital arrival-time detector 170 is by using a phase-frequency detectors 132 (PFD) and a complementary PFD 134 to produce two precise arrival signals from each of the two input signals, the reference input signal 110 and the feedback signal 112 from the VCO. Both the arrival signals produced from the PFDs contain the arrival-time information from both input signals. Normally, the polarity of the arrival signal at the output of PFD 132 generated from the leading arrival edge of reference input signal 110 is positive and the polarity of the arrival signal at the output of the complementary PFD 134 generated from the leading arrival edge of feedback signal 112 from VCO 108 is negative. A polarity selection circuit 142 then selects the first arrival signal, either the positive arrival signal generated by the PFD 132 from the arrival of reference input signal 110 or the negative arrival signal generated by the complementary PFD 134 from the arrival of the feedback signal 112 from VCO 108, as the final polarity output signal 144 for the charge pump output driver 146 to determine the polarity of the error output 114 to either speed up or to slow down the arrival of feedback signal 112 from the VCO. As a result, the arrival of the feedback signal 112 from VCO will be corrected according to the arrival sequence of the two input signals so that the arrival time difference between the feedback signal 112 from VCO and the reference input signal 110 will be constantly reduced by the feedback control loop.

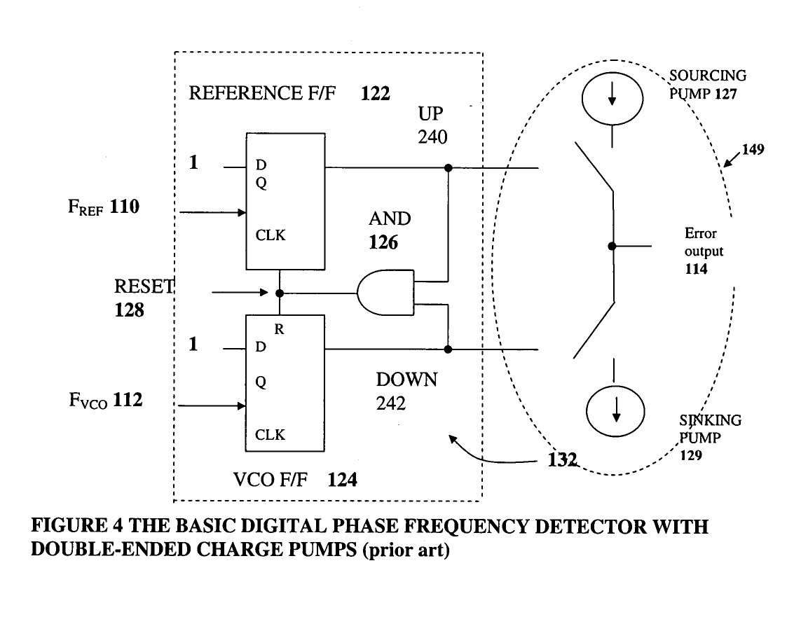

The PFD 132 itself is an arrival-time detector and it is made of two flip-flops and an AND gate. The schematics of a PFD 132 driving a double-ended charge pump output driver 149 as shown in FIG. 4 is an erroneous digital arrival-time detector that produces a dead-zone jittering glitch. Each of the two input signals to the PFD 132 is used as the clock signal for each flip-flop to generate the arrival output signal. The arrival time comparison cycle of the PFD 132 begins when the first arrival signal arrives. One of the two flip-flops of the PFD 132 will be set when the first arrival of input signals arrives and this flip-flop will remain in set condition until the late arrival of the input signals finally arrives. Both flip-flops will be reset shortly after the late arrival of the input signals arrives to complete the arrival-time comparison cycle. After the reset occurs, the PFD 132 is now ready for the new arrival-time comparison cycle to begin. The arrival-time comparison cycle of the PFD is made of an arrival event from each of the two input signals. Since each of the flip-flops of the PFD 132 is clocked by only an input signal separately, the arrival signal outputs generated from the flip-flop are always precise, accurate and without metastability problem.

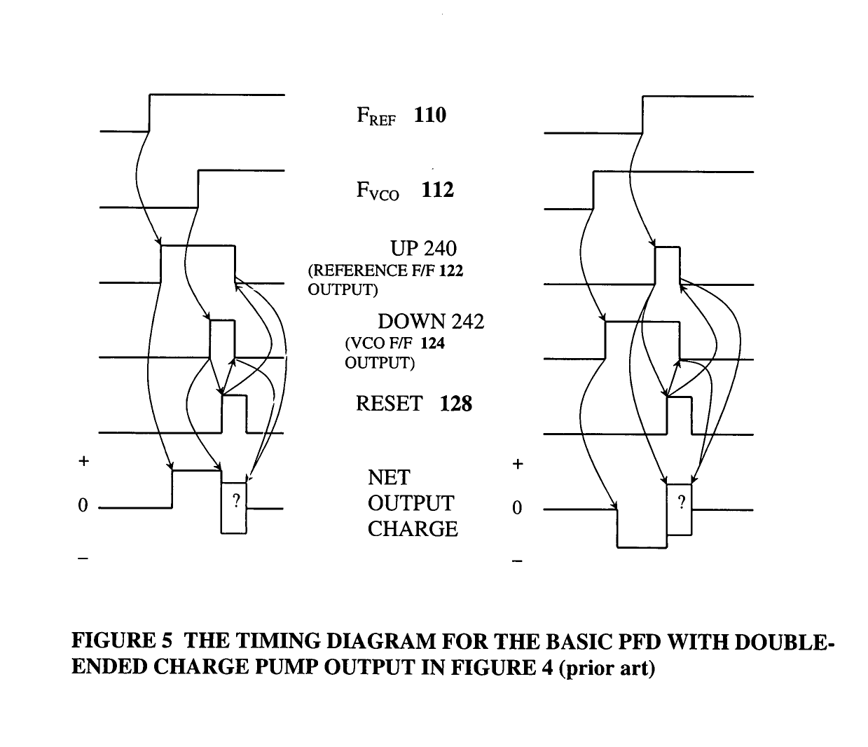

The timing diagram for the operation of PFD 132 driving a double-ended charge pump output driver is shown in FIG. 5. From this figure, it is clear that even thought the PFD 132 can produce two arrival output signals, one from each of the flip-flops; only one of two arrival output signals from the flip-flops contains the arrival-time information from both input signals. We can call the arrival output signal generated from the reference flip-flop 122 by the arrival of reference input signal 110 as UP 240 and the arrival output signal generated from VCO flip-flop 124 by the arrival of feedback signal 112 from the local VCO as the DOWN 242. When the reference signal 110 arrives earlier, only the UP 240 output contains the arrival-time information from both input signals while the DOWN 242 output contains only the arrival-time information of the late arrival feedback signal from VCO 112. And when the feedback signal 112 from VCO arrives earlier, only the DOWN 242 output contains the arrival-time information from both input signals while the UP 240 output contains only the arrival-time information of the late arrival reference input signal 110. In order to produce an error output with the desired arrival-time difference from the PFD 132 regardless of which signal arrives first, a double-ended charge pump 149 is thus needed to perform the subtraction operation for the two arrival signal outputs from the flip-flops. Since the double-ended charge pump 149 is now part of the circuit to produce the error output 114 with the desired arrival-time difference information from both input signals and both charge pump output drivers 149 will inevitably be turned on at the same time at the end of arrival-time comparison period as shown in FIG. 5, a glitch is always generated due to difference of output current from the charge pumps. Since the two charge pumps will never produce exactly the same amount of output current because the intrinsic noise of the devices will never be the same, the glitch is inevitable.

In order to prevent the glitch, we need to produce two arrival output signals, a positive arrival output signal and a negative arrival output signal that both are generated from both of the two input signals with the desired arrival-time difference information for the polarity selection circuit 142 to choose from so that the charge pump output driver 149 can be simply used as the charge pump output driver and has nothing to do with the generation of the arrival-time difference signal. To do that, we need two PFDs 132; a normal PFD 132 to provide a positive arrival signal generated from the arrival of the leading reference input signal 110 and a complementary PFD 134 to provide a negative arrival signal generated from the arrival of the leading feedback signal 112 from VCO as shown in FIG. 3.

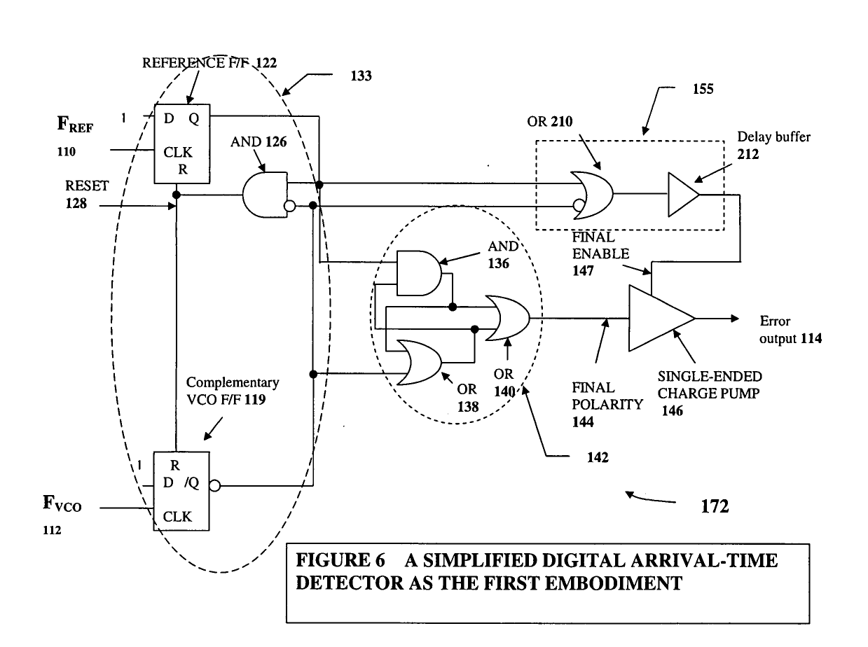

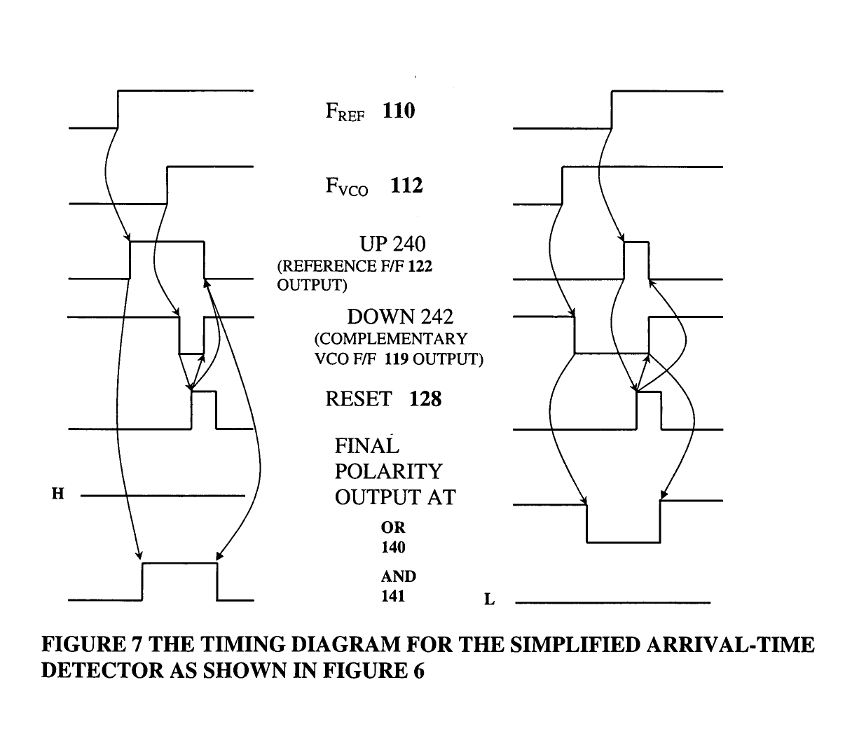

Since both the PFD 132 and the complementary PFD 134 produce two arrival output signals, there are a total of four arrival output signals produced by the PFD 132 and the complementary PFD 134. Since we only need to provide two arrival output signals for the polarity selection circuit 142 to choose from, two of the four arrival output signals from the PFD 132 and complementary PFD 134 are redundant. As a result, we should be able to combine the PFD 132 and the complementary PFD 134 together to become a mixed PFD 133 to produce only the two needed arrival output signals as shown in FIG. 6. The timing diagram of the digital arrival-time detector 172 using mixed PFD 133 is shown in FIG. 7 and from this diagram, we can see clearly that the mixed PFD 133 can indeed provide the needed two arrival signals, a positive arrival signal UP 240 generated from the arrival of the leading reference input signal 110 and a negative arrival signal DOWN 242 generated from the arrival of the leading feedback signal from the VCO 112, for the polarity selection circuit 142 to choose from and the final polarity output 144 is always precise without glitch. The mixed PFD 133 can thus simplify the design for the digital arrival-time detector 172 which is made of four building blocks, the mixed PFD 133, a polarity selection circuit 142, an enable selection circuit 155 and a single-ended charge pump output driver 146.

The final enable signal 147 to the single-ended charge pump output driver 146 determines the duration to enable the charge pump to produce the error output 114 to correct the VCO. The duration of the final enable signal 147 of the digital arrival-time detector 170 shown in FIG. 3 is always equal to the duration of the arrival signal output from either the flip-flop of the PFD 132 or complementary PFD 134 since the enable selection circuit 155 simply chooses either one of the two arrival output signals from the PFD 132 or complementary PFD 134 as the final enable signal 147. Since the duration of the arrival output signal from the PFD 132 and complementary PFD 134 is always longer than the arrival-time difference between the two input signals by the amount that is equal to the sum of the propagation delay of the flip-flop from the reset input and the propagation delay of the AND 126 logic gate, the final enable signal 147 will always have a minimum time period regardless of how small the arrival-time difference between the two input signals is. This minimum time period allows the final enable signal 147 to overcome the input threshold of the single-ended charge pump output driver 146 so that the output from the single-ended charge pump output driver 146 always has the time to swing fully between H and L in two digital states and the dead zone and linear state of the charge pump output driver 146 are completely eliminated regardless of how small the arrival-time difference between the two input signals is. The digital arrival-time detector 170 becomes a perfect digital arrival-time detector.

Even though the simplified design of the digital arrival-time detector 172 as shown in FIG. 6 has a slightly different enable selection circuit 155 than the design as shown in FIG. 3 due to the simplified mixed PFD 133, the design in FIG. 6 still provides the same minimum time period for the final enable signal 147 to guarantee that the charge pump output driver 146 will always swing fully between H and L in two digital states. The delay buffer 212 is needed for the final enable signal 147 so that both the final polarity output signal 144 and the final enable signal 147 will arrive at the charge pump output driver 146 at the same time.

The feedback mechanism between the AND 136 logic gate and the OR 138 logic gate of the polarity selection circuit 142 can block the late arrival signal to prevent it from changing the final polarity output 144 once the final polarity output 144 is selected by the first arrival signal. When the reference input signal 110 arrives first, the output of the AND 136 logic gate will be H and it will force the output of the OR 138 logic gate to be H so that the final polarity output 144 will be H and the late arrival feedback signal 112 from VCO will not be able to change the output of the OR 138 logic gate so that the final polarity output 144 will remain at H state and be locked by the first arrival reference input signal 110. When the feedback signal 112 from VCO arrives first, the output of the OR 138 logic gate will be L and it will force the output of the AND 136 logic gate to be L so that the final polarity output 144 will be L and the late arrival reference input 110 will not be able to change the output of the AND 136 logic gate so that the final polarity output 144 will remain at L state and be locked by the first arrival feedback signal 112. As a result, the state of the final polarity output signal 144 is determined by the first arrival signal and it will remain at the same state until the end of the arrival-time comparison cycle when both signals have arrived and both flip-flops are reset.

Since the OR 140 logic gate favors the H state, the default state of the final polarity output 144 as shown in FIGS. 3 and 6 is H state. This is because an OR 140 logic gate is used to combine the two outputs from the AND 136 and OR 138 logic gates and the default state of the OR 138 logic gate is H due to the complementary output from the VCO F/F 119. The OR 140 logic gate can also be replaced by an AND 141 logic gate. If we do so, since the AND 141 logic gate favors the L state and the default state of the normal output from reference F/F 122 is L, the default state of the final polarity output 144 will be L. The difference of default state does not affect the accuracy of final polarity output 144 of the polarity selection circuit 142 and the polarity selection circuit 142 will always produce an accurate final polarity output 144 no matter which default state is used as shown in FIG. 7.

Although the feedback mechanism between the AND 136 and OR 138 logic gates of the polarity selection circuit 142 can precisely select the leading arrival output signal generated from the flip-flops of the PFD as the final polarity output signal 144, the feedback mechanism can produce bouncing final polarity decision output 144 when the arrival-time difference between the two input signals is smaller than the propagation delay time of a single logic gate. The bouncing decision occurs because for the feedback mechanism between the AND 136 and OR 138 logic gates to completely block the late arrival signal to prevent it from switching the final polarity output signal 144, the output of the AND 136 or OR 138 logic gate must be generated first from the first arrival signal before the output of AND 136 or OR 138 logic gate can block the late arrival signal to prevent it from switching the final polarity output 144. Since it takes time, which is precisely equal to the propagation delay time of a single logic gate for the output of AND 136 or OR 138 logic gates to be produced from the first arrival of either one of the two arrival output signals generated from the PFD 132 and complementary PFD 134 or generated from the normal flip-flop 122 and the complementary flip-flop 119 of the mixed PFD 133, the output of the AND 136 or OR 138 logic gate will not be able to block the late arrival signal completely if the arrival-time difference between the two input signals is less than the propagation delay of a single logic gate. In other words, when the arrival-time difference between the two input signals is less than the propagation delay of a single logic gate, the late arrival signal will arrive before the output of the AND 136 or OR 138 logic gate is generated so that the output of the AND 136 or OR 138 logic gate will not be able to block the late arrival signal completely and the output of the AND 136 and OR 138 logic gates can thus bounce.

The bouncing at the output of AND 136 and OR 138 logic gates will occur when the arrival-time difference between the two input signals is less than the propagation delay of a single logic gate regardless of which signal is leading. When the outputs of AND 136 and OR 138 logic gates are bouncing, the outputs of the AND 136 and OR 138 will not stay in the same state all the time. This is in contrary to the normal operation when the outputs of the AND 136 and OR 138 logic gates do not bounce. In the normal operation of the arrival polarity selection circuit 142 when the outputs of the AND 136 and OR 138 logic gates do not bounce, both the outputs of AND 136 and OR 138 logic gates always stay at the same state.

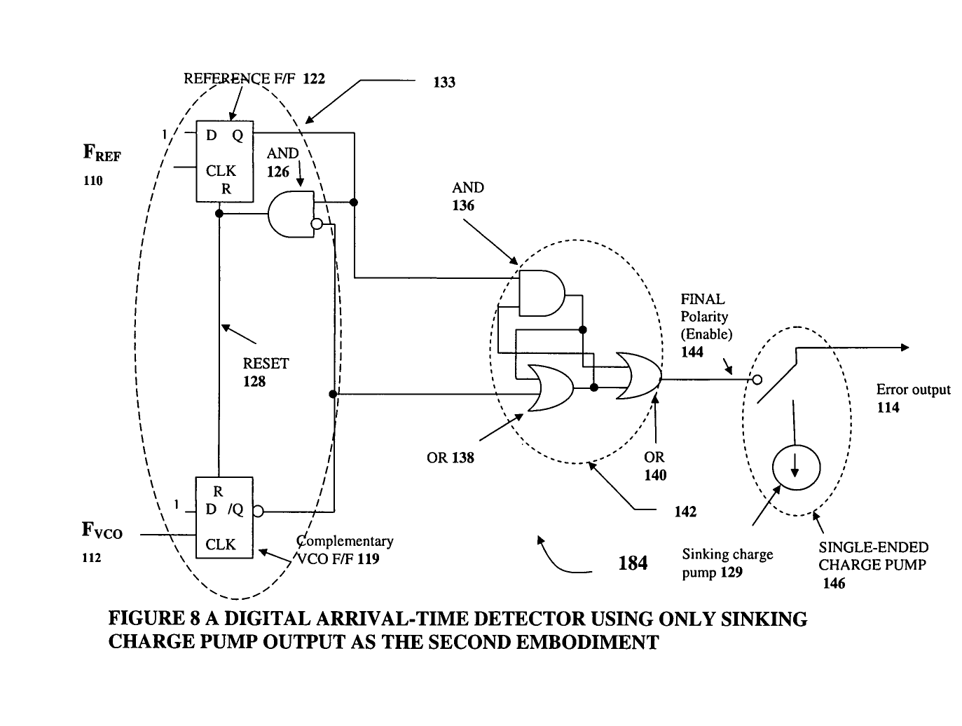

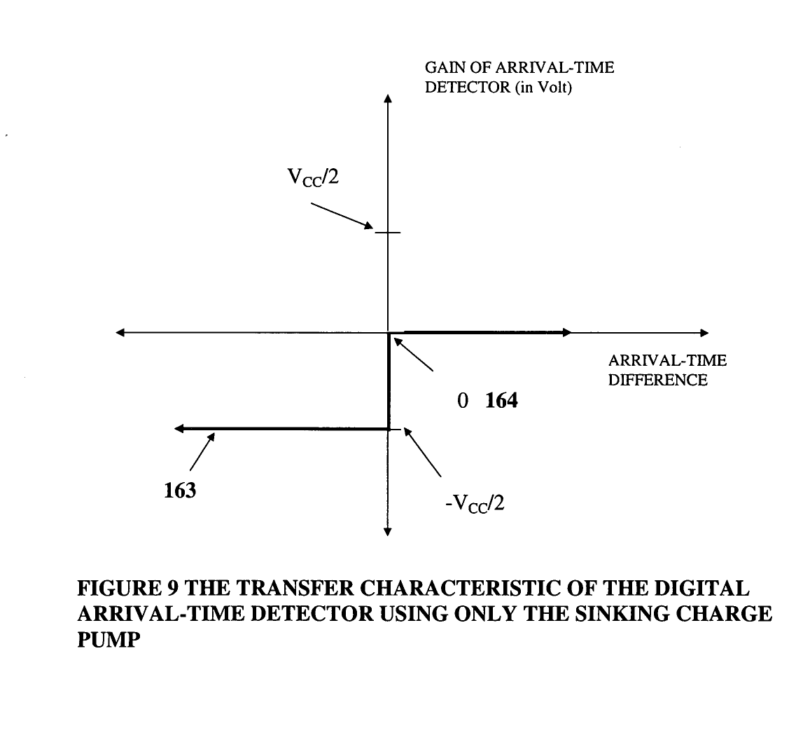

If we use an OR 140 logic gate to combine the outputs from the AND 136 and OR 138 logic gates as shown in FIGS. 3 and 6 to produce the final polarity output 144, since the final polarity output 144 will remain H when either output from the AND 136 or OR 138 logic gate is H, the final polarity output 144 can remain H even when the outputs from the AND 136 and OR 138 logic gates are bouncing. Since the default state of the final polarity output 144 is H when an OR logic gate 140 is used to combine the two outputs from the AND 136 and OR 138 logic gates to produce the final polarity output 144 due to the complementary output from VCO F/F 119, the final polarity output 144 will remain H all the time as long as the reference input signal 110 is the leading signal. When the reference input signal 110 starts to fall behind the feedback signal 112, the final polarity output 144 will bounce between H and L in the beginning. The bouncing of the final polarity output 144 will be stopped and the final polarity output 144 will remain L constantly when the reference input signal 110 is behind the feedback signal 112 from VCO by more than the propagation delay time of a single logic gate. As a result, the use of an OR 140 logic gate to produce the final polarity output 144 will produce no output until the reference signal 110 is falling behind the feedback signal 112. We can apply this important characteristic of the final polarity output 144, generated from using an OR logic gate 140 to combine the outputs from AND 136 and OR 138 logic gates, to use this final polarity output signal 144 as the enable signal 144 to enable a sinking charge pump 129 as shown in FIG. 8 so that the sinking charge pump 129 will remain inactive as long as the reference input signal 110 is the leading signal. The sinking charge pump 129 will start to produce output when the feedback signal 112 becomes the leading signal. When the feedback signal 112 is ahead of the reference signal 110 by less than the propagation delay time of a single logic gate, the final enable signal 144 to the sinking charge pump 129 will bounce between H and L. The correct state of the final enable signal 144 to the sinking charge pump 129 should be L when the feedback signal 112 is the leading signal. Luckily, even when the final enable signal 144 to the sinking charge pump 129 is bouncing between H and L, the polarity of output current from the sinking charge pump 129 will always be accurate because an erroneous H output of the final enable signal 144 will never produce an output from the sinking charge pump 129. The transfer characteristic of the digital arrival-time detector using only a sinking charge pump as shown in FIG. 8 can be plotted in FIG. 9 and the digital arrival-time detector using only a sinking charge pump output 184 as shown in FIG. 8 satisfies the first requirement for the ideal data clock recovery system.

The design of the digital arrival-time detector 184 using only a sinking charge pump output driver as shown in FIG. 8 is made of only three building blocks, the mixed PFD 133, the polarity selection circuit 142 and the single-ended charge pump output driver 146. The digital arrival-time detector 184 can only produce a negative error output 114 to slow down the arrival of feedback signal 112 from VCO and the error output 114 lasts slightly longer than the arrival-time difference between the two input signals when the feedback signal 112 from VCO is the leading input signal.

The gain of the digital arrival-time detector 184 should have Amp as the unit because a charge pump output driver is used to produce the error output signal 114 and the error output signal is a current signal. Since the error output signal 114 will eventually become the final error correction output signal 115 to correct the voltage controlled oscillator (VCO) and the final error correction output signal must be a voltage signal, the error output signal 114 can then be represented as a voltage signal as well even though it is generated from a current source. As a result, the gain of the digital arrival-time detector 184 can have Volt as the unit and it is usually easier to use Volt as the unit for the gain of digital arrival-time detectors, instead of Amp.

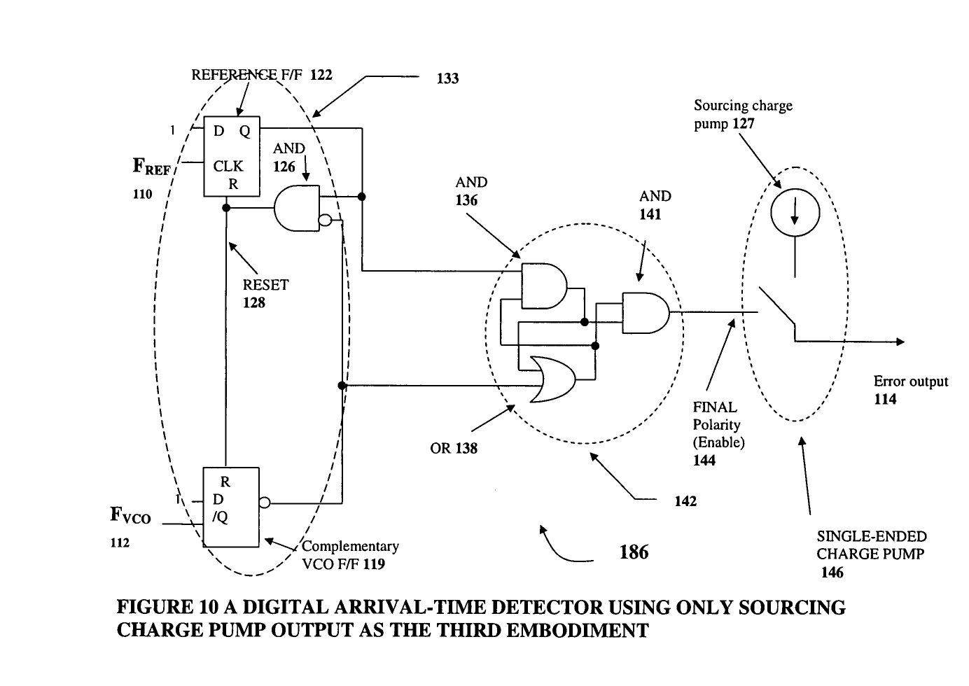

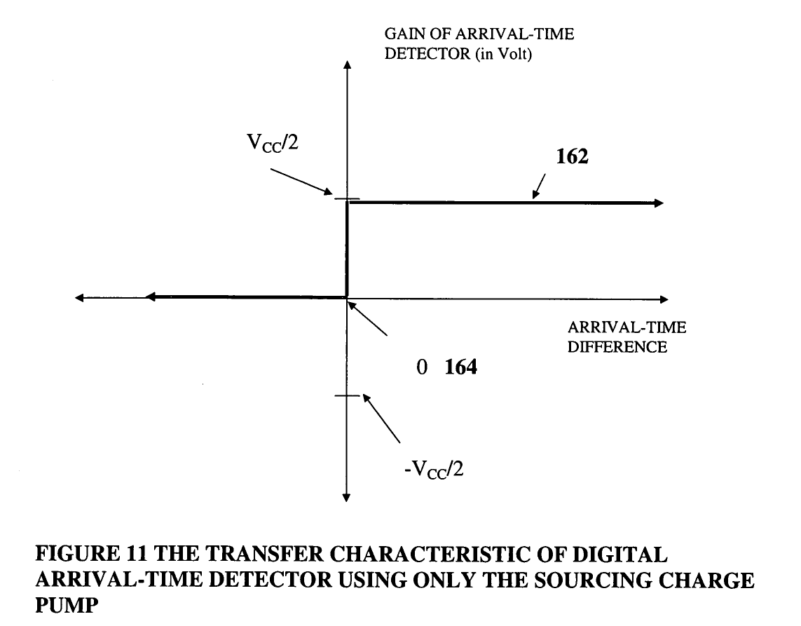

If we use an AND 141 logic gate to combine the outputs from the AND 136 and OR 138 logic gates to produce the final polarity output 144, since the final polarity output 144 will remain L when either output from the AND 136 or OR 138 logic gate is L, the final polarity output 144 will remain L even when the outputs of AND 136 and OR 138 logic gates are bouncing. Since the default state of the final polarity output 144 is L when an AND logic gate 141 is used to combine the two outputs from the AND 136 and OR 138 logic gates to produce the final polarity output 144 due to the output from the reference F/F 122, the final polarity output 144 will remain L all the time as long as the feedback signal is the leading signal. When the feedback signal 112 from VCO starts to fall behind the reference input signal 110, the final polarity output 144 will start to bounce between H and L in the beginning. The bouncing will be stopped and the final polarity output 144 will remain H constantly when the feedback signal 112 from VCO is behind the reference input signal 110 by more than the propagation delay time of a single logic gate. As a result, the use of an AND 141 logic gate to produce the final polarity output 144 will produce no output until the feedback signal 112 is falling behind the reference signal 110. We can apply this important characteristic of final polarity output 144, generated by using an AND logic gate 141 to combine the outputs from AND 136 and OR 138 logic gates, to use this final polarity output signal 144 as the enable signal 144 to enable a sourcing charge pump 127 as shown in FIG. 10 so that the sourcing charge pump 127 will remain inactive as long as the feedback signal 112 is the leading signal. The sourcing charge pump 127 will start to produce output when the reference input signal 110 becomes the leading signal. When the reference input signal 110 is leading the feedback signal 112 by less than the propagation delay time of a single logic gate, the final enable signal 144 to the sourcing charge pump 127 will bounce between H and L. The correct state of the final enable signal 144 to the sourcing charge pump 127 when the reference input signal 110 is the leading signal is H. Luckily, even when the final enable signal 144 to the sourcing charge pump 127 is bouncing between H and L, the polarity of the error output 114 from the sourcing charge pump 127 will always be accurate because the erroneous L output at the final enable signal 144 will never produce an output from the sourcing charge pump 127. The transfer characteristic of the circuit as shown in FIG. 10 can be plotted in FIG. 11 and the digital arrival-time detector using only the sourcing charge pump output 186 as shown in FIG. 10 satisfies the second requirement for the ideal data clock recovery system.

The design of the digital arrival-time detector 186 using only a sourcing charge pump output driver as shown in FIG. 10 is also made of only three building blocks, the mixed PFD 133, the polarity selection circuit 142 and the single-ended charge pump output driver 146. The digital arrival-time detector 186 can only produce a positive error output 114 to speed up the arrival of feedback signal 112 from VCO and the error output 114 lasts slightly longer than the arrival-time difference between the two input signals when the reference input signal 110 is the leading input signal.

As can be seen from FIGS. 11 and 9, the use of AND 141 and OR 140 logic gates to produce the final polarity outputs 144 from the AND 136 and OR 138 logic gates produces two exclusive final polarity outputs 144 that never overlap so that the two exclusive final polarity outputs 144 can be used to control two separate charge pumps 127 and 129 and the output of the two charge pumps will never be turned on at the same time. Since the charge pumps 127 and 129 are only used to produce the output current for the final polarity signal 144 and the two charge pumps won't be enabled at the same time, the dead zone jittering glitch that is inherent to current PFD 132 is prevented.

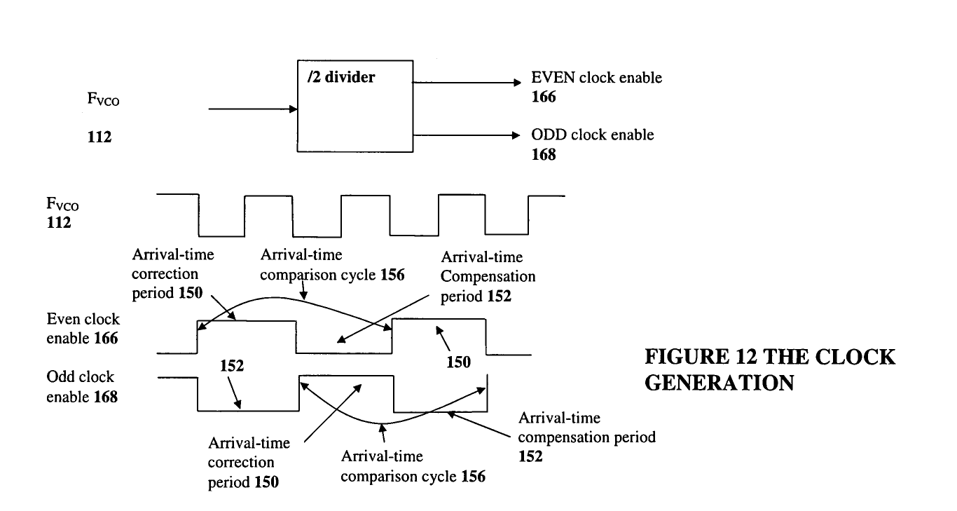

Since the absence of arrival edges in the input data stream 110 can cause the digital arrival-time detector 184 to produce an erroneous error output 114 to correct the VCO, if we use the input data stream 110 from a communication channel to replace the reference input signal 110 of the digital arrival-time detectors 184 and to use the digital arrival-time detector 184 to recover the clock signal from the input data stream 110, we need to compensate for this erroneous output immediately once we found out the absence of arrival edge in the input data stream 110. Unfortunately, we can only find out the absence of arrival edge in the input data stream 110 after the current arrival-time comparison period is over. As a result, we need an extra arrival-time compensation period immediately afterward to compensate for the erroneous output due to the absence of arrival edge in the input data stream 110 so that a complete arrival-time comparison cycle 156 for an ideal data clock recovery system should consist of two periods of the arrival-time comparison signal which is also the same as two periods of feedback signal 112 from VCO. We can call the first period of the feedback signal 112 in the arrival-time comparison cycle 156 as the arrival-time correction period 150 and the second period of the feedback signal 112 in the arrival-time comparison cycle 156 as the arrival-time compensation period 152 as shown in FIG. 12.

In order to implement the data clock recovery system with two periods of arrival-time comparison signal, we need to separate the even and odd clock edges of the feedback signal 112 from VCO and process the arrival-time comparison of the input data stream 110 with the even and odd clocks of the feedback signal 112 from VCO alternatively. To do that, we need a divide-by-two frequency divider to produce two enable output signals, the even clock enable signal 166 and the odd clock enable signal 168. Both the clock enable signals stay at the H and L level alternatively for exactly a clock period of the feedback signal 112 from VCO. With these two clock enable signals, we can separate the arrival of even clocks and odd clocks of the feedback signal 112 from VCO.

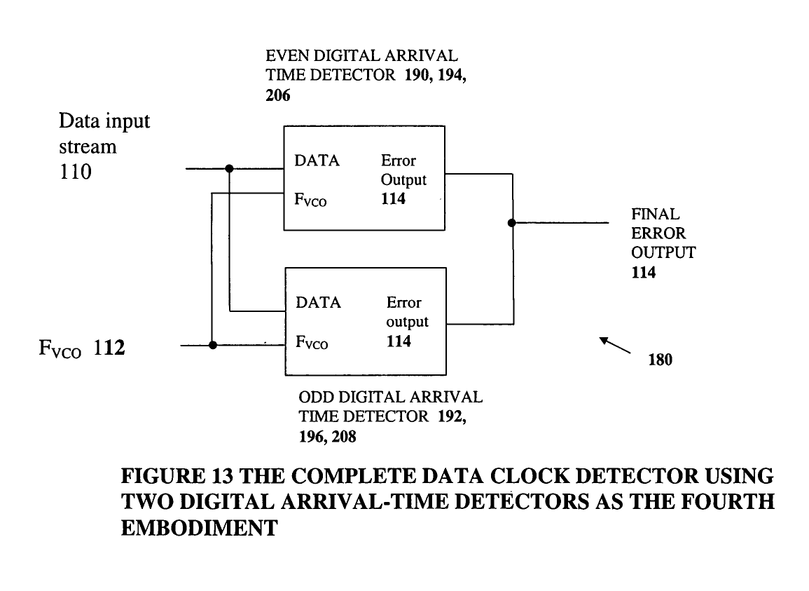

If we do so, then we will need an even digital arrival-time detector (190, 194 and 206) for every even clock edge of the feedback signal 112 from the local VCO 108 and an odd digital arrival-time detector (192, 196 and 208) for every odd clock edge of the feedback signal 112 from the local VCO 108 to complete the design of the data clock detector 180 as shown in FIG. 13. With two separate digital arrival-time detectors, we will then be able to isolate each arrival edge of the feedback signal 112 from VCO and treat every arrival edge of the feedback signal 112 from VCO as a new arrival-time synchronization event and apply the three rules of algorithm to compare each of the arrival edge of the feedback signal 112 from VCO with the arrival edge of the input data stream 110 to produce an error output 114 that eventually becomes the final error correction output 115 to correct the VCO.

The even clock enable signal 166 and odd clock enable signal 168 should be generated from the falling edge of the feedback signal 112 from VCO so that, ideally, the rising edge of the feedback signal 112 from VCO is located at the center of the even clock enable signal 166 and odd clock enable signal 168. As a result, the rising edge of the feedback signal 112 from VCO always arrive at 180 degree of the phase and the arrival-time correction period 150 always begins at 0 degree and ends at 360 degrees of the phase of feedback signal 112 from VCO. During the arrival-time correction period 150, the arrival-time detector will be in the active mode to produce an error correction output according to the arrival sequence and arrival-time difference between the two input signals to correct the VCO while during the arrival-time compensation period 152, the arrival-time detector will be in the reset condition and stay in the idle mode and will not be able to produce error output 114 according to the arrival sequence and arrival-time difference between the two input signals. The two arrival-time detectors, even and odd arrival-time detectors, will stay in the active mode and idle mode alternatively. At any moment, only either one of the two digital arrival-time detectors will be in the active mode producing an error output signal 114 to affect the final error correction output 115 to correct the VCO according to the arrival sequence and arrival-time difference between the two input signals.

Once we separate the even clocks from the odd clocks of the feedback signal 112 from VCO, we can handle the missing of arrival edges in the input data stream 110 easily. This is because that only the even digital arrival-time detector (190, 194 and 206) will be actively producing an error output 114 to affect the final error correction output 115 to correct the VCO according to the arrival sequence and arrival-time difference between the two input signals during the arrival-time correction period 150 when the even clock enable signal 166 is true. If there was no arrival edge in the input data stream 110 during arrival-time correction period 150 when the even clock enable signal 166 was true, then the VCO would have been corrected by mistake and the final error correction voltage to the VCO 115 stored on the loop filter 106 would have been sunk down by the even digital arrival-time detector (190, 194 and 206) for a period, which is equal to half the period of the feedback signal 112 from VCO plus the sum of the propagation delay of the flip-flop from the reset input and the propagation delay of the AND 126 logic gate, since the feedback signal 112 from VCO was the only signal arrived at the even digital arrival-time detector (190, 194 and 206) during the arrival-time correction period 150 when the even clock enable signal 166 was true. Since we know exactly how much charges has been removed form the loop filter 106 and how much the voltage of the final error correction output voltage 115 has been corrected by mistake, we can correct the mistake during the following arrival-time compensation period 152 when the even clock enable signal 166 is false by pumping the same amount of charges that was removed from the loop filter by mistake during the previous arrival-time correction period 150 back to the loop filter 106 during the current arrival-time compensation period 152 and restoring the final error correction output voltage 115 to where it was before the erroneous correction occurred during the previous arrival-time correction period 150. If we put back exactly the same amount of charges as the amount of charge that was removed by mistake during the previous arrival-time correction period 150 when the even clock enable signal 166 was true back to the loop filter 106 during the current arrival-time compensation period 152 when the even clock enable signal 166 is false, then the net effect from the even digital arrival-time detector (190, 194 and 206) will be zero at the end of arrival-time comparison cycle 156 of the even clock and the third requirement of the algorithm is thus satisfied.

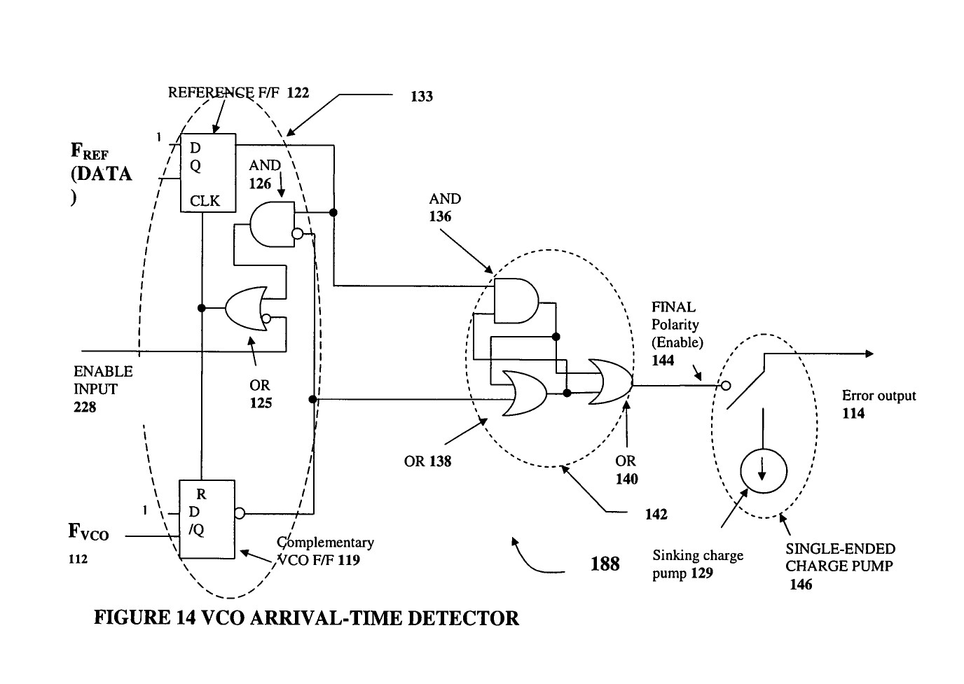

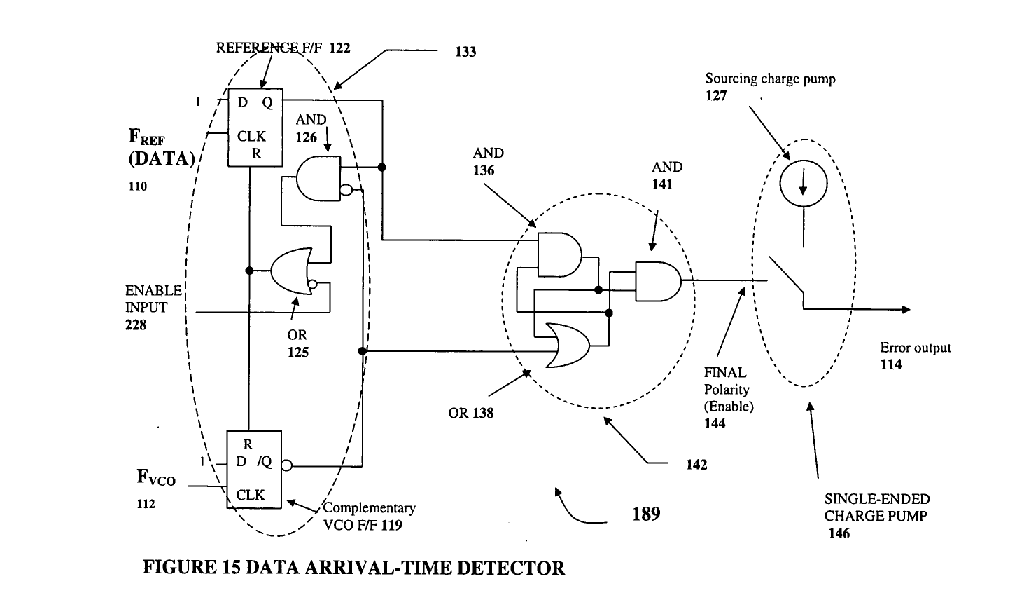

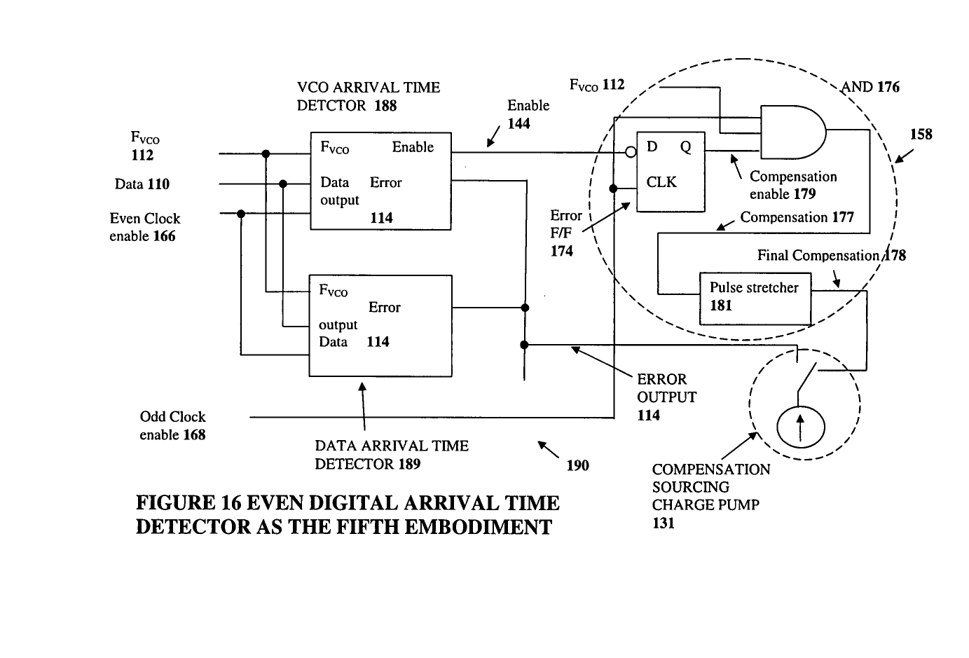

To build the even and odd arrival-time detectors, we need to add an enable input 228 to both the digital arrival-time detector using only a sinking charge pump 184 as shown in FIG. 8 and the digital arrival-time detector using only a sourcing charge pump 186 as shown in FIG. 10 so that both arrival-time detectors will be in the default state at the beginning of each arrival-time correction period 150 and ready to produce the error output 114 from the arrival-time sequence and arrival-time difference between the two input signals when the enable signal input 228 is true and both arrival-time detectors will stay in the reset state without producing error output 114 according to the arrival sequence and arrival-time difference between the two input signals when the enable input signal 228 is false. We will call the new digital arrival-time detector using only a sinking charge pump output driver 129 with the enable input 228 shown in FIG. 14 as the VCO arrival-time detector 188 since only the arrival of the leading feedback signal 112 from VCO can produce a negative error output 114 from this circuit. We will also call the digital arrival-time detector using only a sourcing charge pump output driver 127 with an enable input 228 shown in FIG. 15 as the Data arrival-time detector 189 since only the arrival of the leading data input stream 110 can produce a positive error output 114 from this circuit. The reference input 110 of the digital arrival-time detector is now called the data input 110 when the digital arrival-time detector is used for the data clock recovery system. The schematics for the even digital arrival-time detector 190 can be shown as in FIG. 16. In this design, a VCO arrival-time detector 188 is used to satisfy the first rule and a Data arrival-time detector 189 is used to satisfy the second rule and a compensation circuit 158 along with a compensation sourcing charge pump 131 are used to satisfy the third rule of the algorithm. The compensation circuit 158 is made of a D flip-flop 174 and an AND logic gate 176 and a pulse stretcher circuit 181 to produce a final compensation signal 178 to control the compensation sourcing charge pump 131 to restore the final error correction output 115 during the arrival-time compensation period 152. The compensation circuit 158 will only be active when there is no arrival edge of the input data stream 110 during the arrival-time correction period 150. The presence or absence of the arrival edge in the input data stream 110 during the arrival-time correction period 150 can be identified by the state of the final polarity output 144 at the end of the arrival-time correction period 150. Since the final polarity output 144 of the VCO arrival-time detector 188 will be reset to the default H state after the arrival of both input signals, we can be certain that the arrival edge from the input data stream 110 must be absent if the final polarity output 144 is not in the default H state at the end of arrival-time correction period 150. We can implement this algorithm to generate a compensation enable signal 179 from the error flip-flop 174 by using the odd clock enable signal 168, whose arrival indicates the end of arrival-time correction period 150 of the even clock, to clock out the final polarity (enable) output 144 of the VCO arrival-time detector 188. The output of the error flip-flop 174, which is the compensation enable signal 179, is then ANDed with both the odd clock enable signal 168 and the feedbacks signal 112 from VCO to produce a compensation signal 177 that can only exist during the arrival-time compensation period 152 and the duration of compensation signal 177 is equal to half of the period of the feedback signal 112 from VCO, assuming that the feedback signal 112 from VCO has 50% duty cycle. Since the duration of erroneous correction to the VCO when the arrival edge of the input data stream 110 is absent during the arrival-time correction period 150 always lasts longer than half of the period of the feedback signal 112 from VCO by the amount that is equal to the sum of the propagation delay of the flip-flop from the reset input and the propagation delay of the AND logic gate 126 and OR logic gate 125, a pulse stretcher circuit 181 can then be used to stretch the width of the compensation signal 177 so that the final compensation signal 178 lasts as long as the erroneous correction to the VCO during the arrival-time correction period 150 to produce the same correction voltage to the final error correction output 115 to cancel out the erroneous correction voltage to the final error correction output 115 occurred during the arrival-time correction period 150. The compensation sourcing charge pump 131 used during the arrival-time compensation period 152 is the third charge pump for the even clock arrival-time detector 190 of the data clock detector 180 to satisfy the third rule of the algorithm. Ideally, the amplitude of output current from all the charge pumps, including the sourcing charge pump 127, the sinking charge pump 129 and the compensation sourcing charge pump 131 should be all the same.

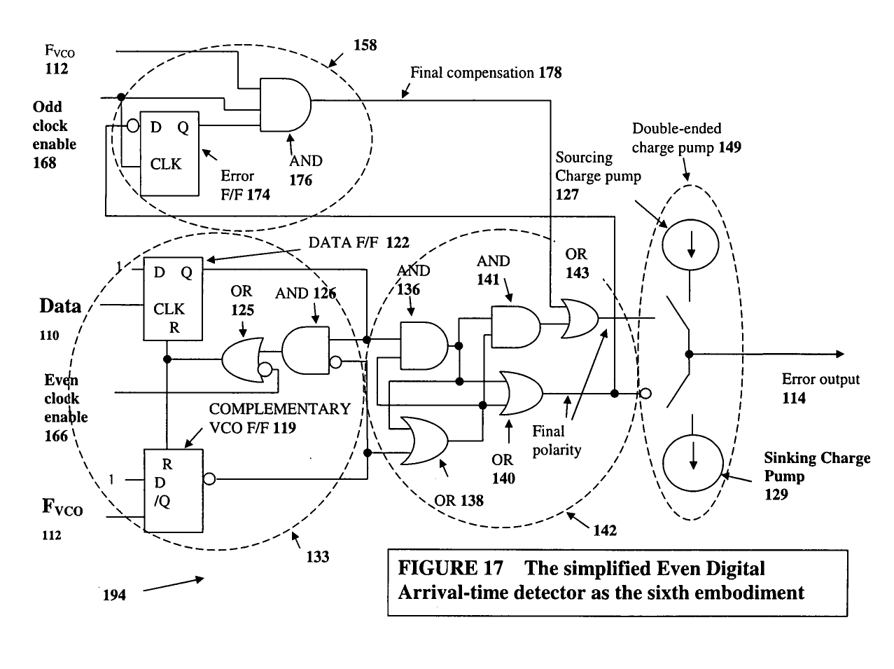

We can even combine the VCO arrival-time detector 188 and the Data arrival-time detector 189 further to save the hardware since they both use the same mixed PFD 133. The simplified even digital arrival-time detector 194 is shown as in FIG. 17. In the simplified design 194 of the even digital arrival-time detectors, both the pulse stretcher circuit 181 and the compensation sourcing charge pump 131 can be eliminated if the frequency of the data input stream 110 is fixed and the amount of current output from the sinking charge pump output driver 129 is slightly smaller than the amount of current output from the sourcing charge pump output driver 127 so that the net correction to the final error correction output 115 is zero at the end of the arrival-time comparison cycle 156 when there was no arrival edge in the input data stream 110 during the arrival-time correction period 150. The output current from the sinking charge pump output driver 129 in the design of simplified digital arrival-time detector (194 and 206) must be smaller than the output current from the sourcing charge pump output driver 127 because the duration of erroneous correction during the arrival-time correction period 150 when the arrival edge of input data 110 was absent is slightly longer than half of the period of the feedback signal 112 from VCO but the duration of the final compensation correction output 178 during the compensation period 152 is always equal to half of the period of the feedback signal 112 from VCO. As a result, the sinking charge pump 129 must produce slightly less current than the sourcing charge pump 127 so that the net correction output to the final error correction 115 can be zero at the end of arrival-time comparison cycle 156 when the arrival edge of the input data stream 110 was absent during the arrival-time correction period 150 to satisfy the third requirement. The slight difference of current output from the sinking charge pump 129 and sourcing charge pump 127 output drivers does affect the gain of the even digital arrival-time detector in normal operation when the arrival edge from the input data stream 110 is present; however, as long as the output of the charge pump outputs can still swing fully between H and L in two digital state, the slight difference of the current output does not have severe adverse effect to the operation of the loop.

In the simplified design of the even digital arrival-time detector 194, since the sinking charge pump 129 will always be enabled for a period longer than the sourcing charge pump 127 by a fixed amount of time when the arrival edge in the input data stream 110 is absent, the frequency of the input data stream 110 must be fixed if the pulse stretcher circuit 181 is not used. Without using the pulse stretcher circuit 181 to equalize the enabling time for the charge pump output drivers, we are compensating the difference of enabling time between two charge pump output drivers with the difference of current output from the charge pump output drivers. Since the output current of charge pump is fixed and the difference of output current from the two charge pumps is also fixed and the amount of difference in enabling time of the charge pumps is also fixed, the frequency of the input data stream 110 must be also fixed.

The simplified even digital arrival-time detector as shown in FIG. 17 is made of four building blocks, the mixed PFD 133, a polarity selection circuit 142, a compensation circuit 158 and a double-ended charge pump output driver 149. An OR 143 logic gate is used to combine the final polarity output from the AND 141 logic gate with the final compensation signal 178 from the compensation circuit 158 to become the final polarity output 144 for the sourcing charge pump 127 in order to save the extra compensation charge pump output driver 131 used in the even digital arrival-time detector 190 shown in FIG. 16.

For an optimal design of the data clock detector 180, the pulse stretcher circuit 181 should always be used in the compensation circuit 158 to equalize the duration of the final compensation signal 178 occurred during the arrival-time compensation period 152 to be the same as the duration of the erroneous correction to the sinking charge pump 129 occurred due to absence of arrival edge in the input data stream 110 during the arrival-time correction period 150. As a result, the sourcing charge pump 127 will be enabled in the arrival-time compensation period 152 for the same duration that the sinking charge pump 129 was enabled when the arrival edge of the input data stream 110 was absent during the arrival-time correction period 150. With the same enabling time, the amount of output current from the sourcing charge pump 127 and sinking charge pump 129 can then be the same. The use of the pulse stretcher circuit 181 can ensure that the gain of the even digital arrival-time detector 194 is well balanced in the normal operation when the arrival edge of the input data stream is present and the operation of the data clock detector 180 is thus optimized.

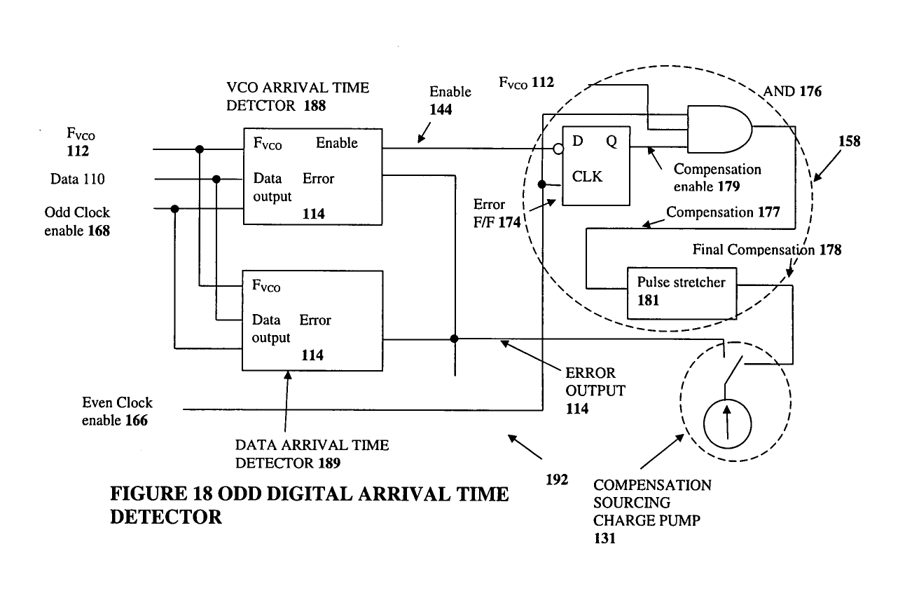

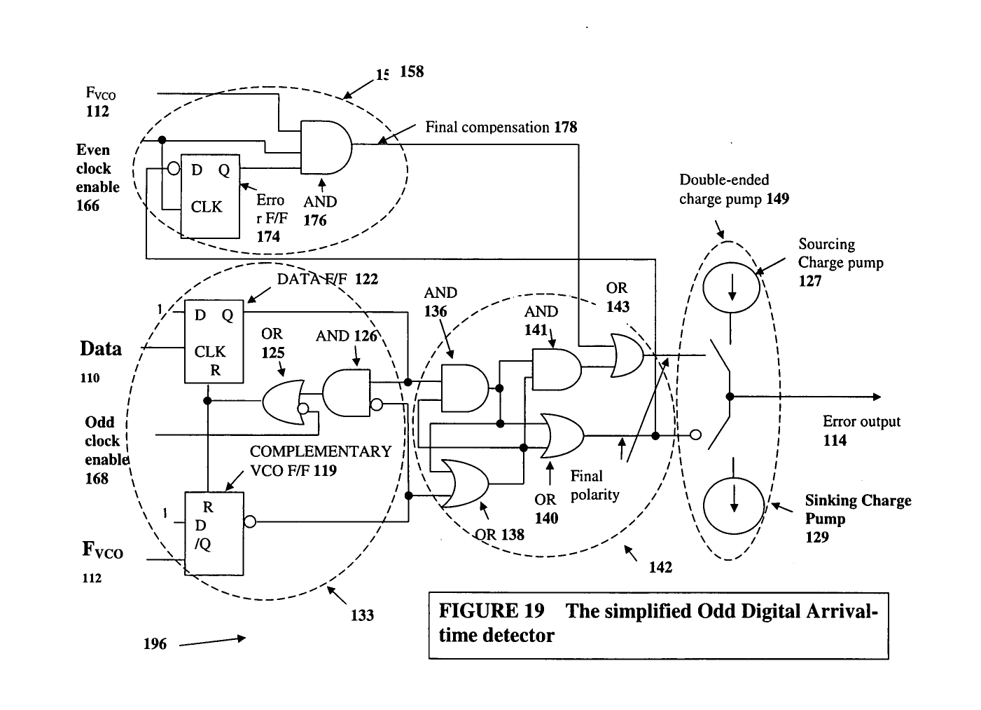

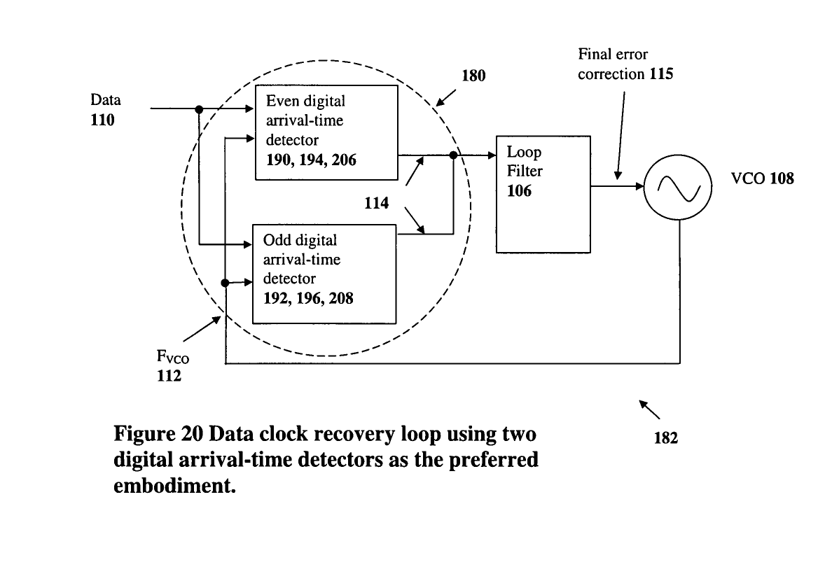

We can duplicate the even digital arrival-time detector (190 and 194) as shown in FIGS. 16 and 17 and change them into the odd digital arrival-time detector (192 and 196) as shown in FIGS. 18 and 19 by simply swapping the even clock enable 166 and odd clock enable 168 signals. The even (190, 194) and odd (192, 196) digital arrival-time detectors can then be combined to become the complete data clock detector 180. If we use the data clock detector 180 to replace the arrival-time detector 104 of the arrival-time locked loop 100, the new feedback control loop will become the data clock recovery loop 182 as shown in FIG. 20 to produce a stable feedback signal 112 from VCO that always arrive at the data clock detector 180 at the same time as the data input stream 110 when the arrival edge of the data input stream 110 arrives.

The data clock detector 180 produces an error output signal 114 to correct the arrival of the feedback signal 112 from VCO. The error output signal 114 is produced according to the three rules of the algorithm so that a positive error output 114 with the duration determined by the arrival-time difference between the arrival of data input signal 110 and the arrival of feedback signal 112 from VCO is generated during the arrival-time correction period 150 of the arrival-time comparison cycle 156 to speed up the arrival of feedback signal 112 from VCO when the arrival of feedback signal 112 is behind the arrival of data input stream 110 at the inputs of data clock detector 180 and a negative error output 114 with the duration determined by the arrival time difference between the arrival of data input signal 110 and the arrival of feedback signal 112 from VCO is generated during the arrival-time correction period 150 of the arrival-time comparison cycle 156 to slow down the arrival of feedback signal 112 from VCO when the arrival of feedback signal 112 is ahead of the arrival of data input stream 110 at the inputs of the data clock detector 180 and a net zero error output 114 is generated to maintain the arrival rate of the feedback signal 112 from VCO at the end of the arrival-time comparison cycle 156 to be the same rate as the arrival rate of the feedback signal 112 from VCO at the beginning of the arrival-time comparison cycle 156 when the arrival edge from the data input stream 110 is absent during the arrival-time correction period 150 of the arrival-time comparison cycle 156. The error output 114 signal is filtered out and integrated by the loop filter 106 so that a final error correction output 115 to either speed up or slow down the arrival of the feedback signal 112 from VCO 108 will only be produced linearly according to the arrival sequence and arrival-time difference between the two input signals to the data clock detector 180 when the arrival edge from the data input stream 110 is present during the arrival-time correction period 150 of the arrival-time comparison cycle 156 and the final error correction output 115 to the VCO 108 at the end of current arrival-time comparison cycle 156 will remain at the same level as the final error correction output 115 to the VCO at the beginning of current arrival-time comparison cycle 156 when the arrival edge from the data input stream 110 is absent during the arrival-time correction period 150 of the arrival-time comparison cycle 156. As a result, the arrival-time of the feedback signal 112 from VCO of the data clock recovery loop 182 will be precisely corrected according to the arrival sequence and arrival-time difference between the arrival of the feedback signal 112 from VCO and the arrival of the data input stream signal 110 only when a correction is needed so that the data clock recovery loop 182 can always produce a feedback signal 112 from VCO that always arrives at the input of data clock detector 180 at the same time as the arrival of data input stream 110 even when the arrival edge of data input stream 110 is absent from time to time.

Since the design of data clock detector 180 is based on the arrival edge of the clocks, the duty cycle of the clocks, as long as it is not too small or too large to violate the setup time and hold time requirement of the flip-flops, is irrelevant to the operation of the data clock detector 180. Since the data clock detector 180 can precisely correct the timing error of the arrival of feedback signal 112 from VCO on each and every arrival edge of the input data stream 110 regardless of the presence or absence of the arrival edge in the input data stream 110, it offers a full rate data clock recovery. The performance of the capture and tracking range of the new data clock recovery loop 182 is far superior to most other designs for the data clock recovery. The frequency capture range of the new data clock recovery loop 182 is equal to whole operating frequency range of the VCO 108 just like a regular digital arrival-time locked loop 100. In effect, the new data clock recovery loop 182 is the most general design of the digital arrival-time locked loop 100 because the new data clock recovery loop 182 can be operated even with the absence of arrival edge in the data input stream signal 110.

We can simplify the design of the polarity selection circuit 142 used in the digital arrival-time detector by eliminating the AND 136 and OR 138 logic gates to remove the feedback mechanism between the AND 136 and OR 138 logic gates. Without the feedback mechanism between the AND 136 and OR 138 logic gates, the duration of final polarity output 144 of the polarity selection circuit 142 will be always equal to the arrival-time difference between the two input signals and dead zone is inevitable.

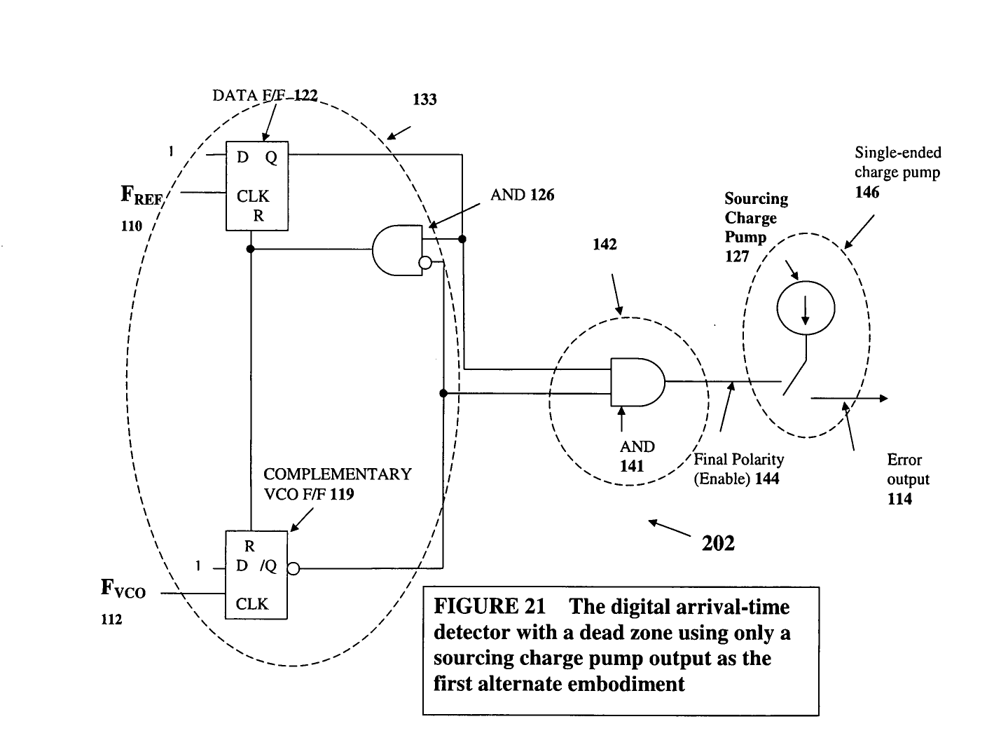

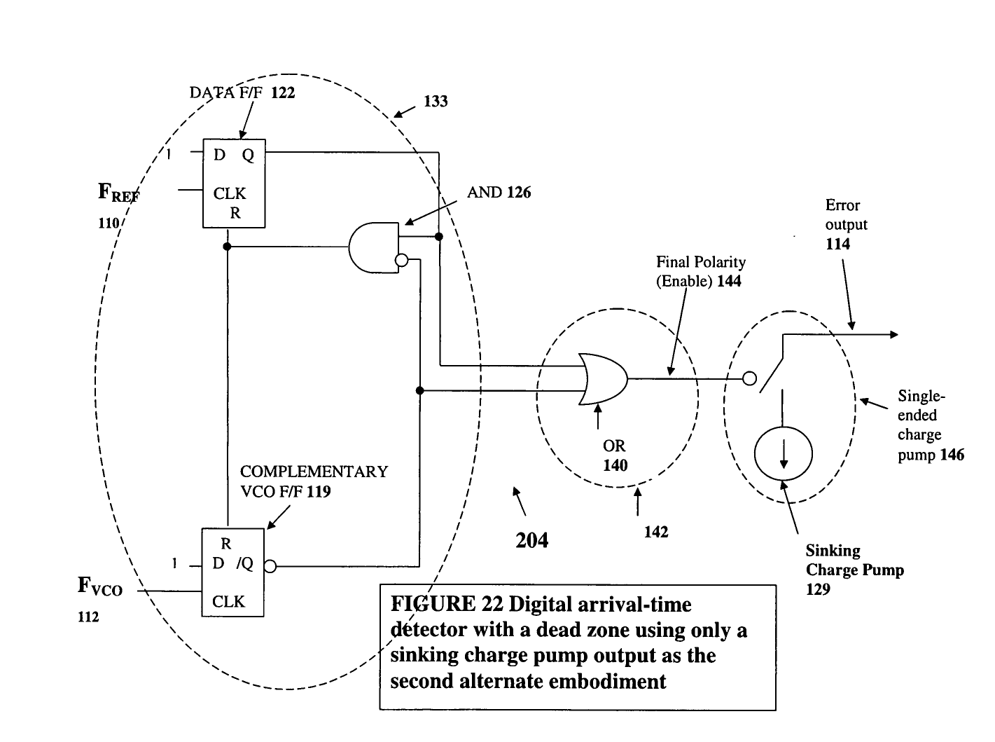

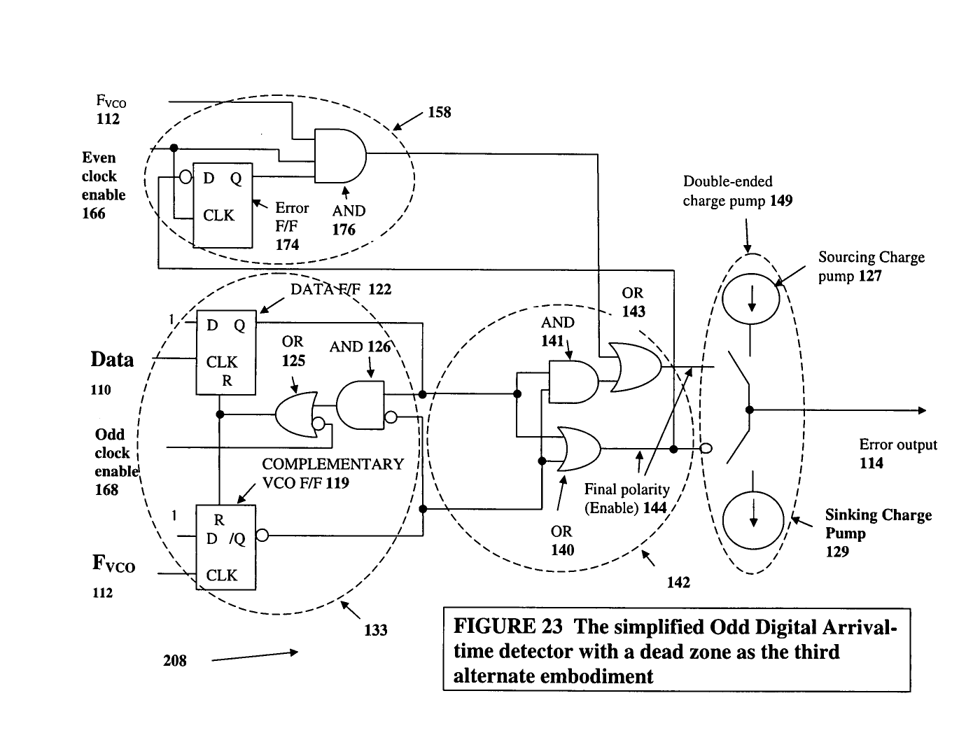

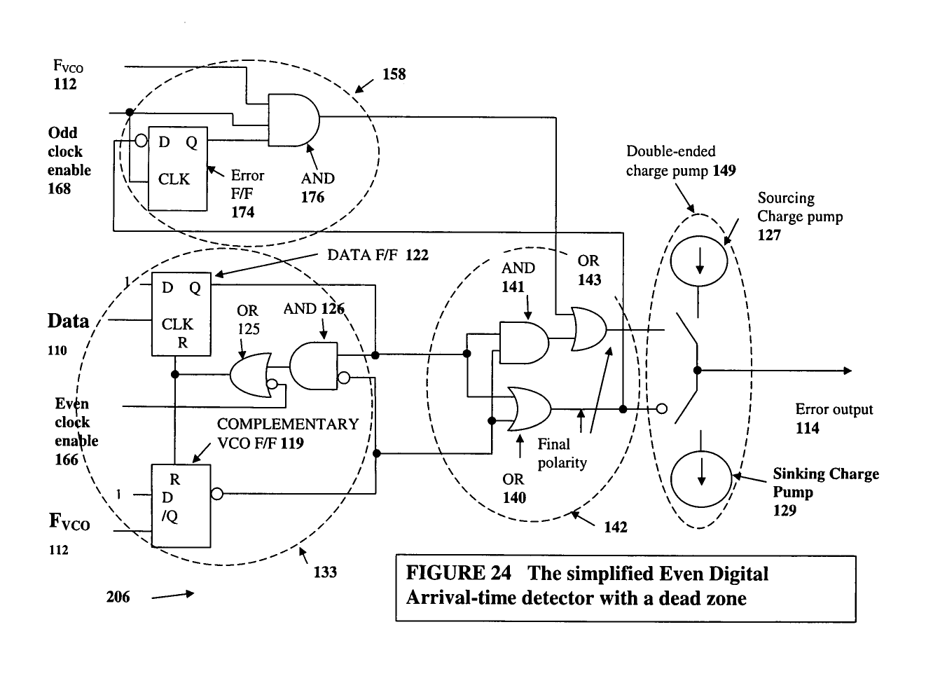

Although the dead zone is an undesired output state of the arrival-time detector since the arrival-time detector can not produce any output when it is operated within the dead zone, the dead zone can produce the least amount of phase noise for the VCO since the VCO is not disturbed when it is operated within the dead zone. The design of the digital arrival-time detector 202 using only a sourcing charge pump output with a dead-zone is as shown in FIG. 21 and the design of the digital arrival-time detector 204 using only a sinking charge pump output with a dead zone is as shown in FIG. 22. The designs as shown in FIGS. 21 and 22 are also the simplest design of the digital arrival-time detector that uses the minimum possible part. Both designs include only three building blocks, the mixed PFD 133, the polarity selection circuit 142 using only a single logic gate and the single-ended charge pump output driver 146. These two designs can be combined and simplified to become a simplified odd arrival-time detector 208 as shown in FIG. 23 and a simplified even arrival-time detector 206 as shown in FIG. 24 to be used in the data clock detector 180.

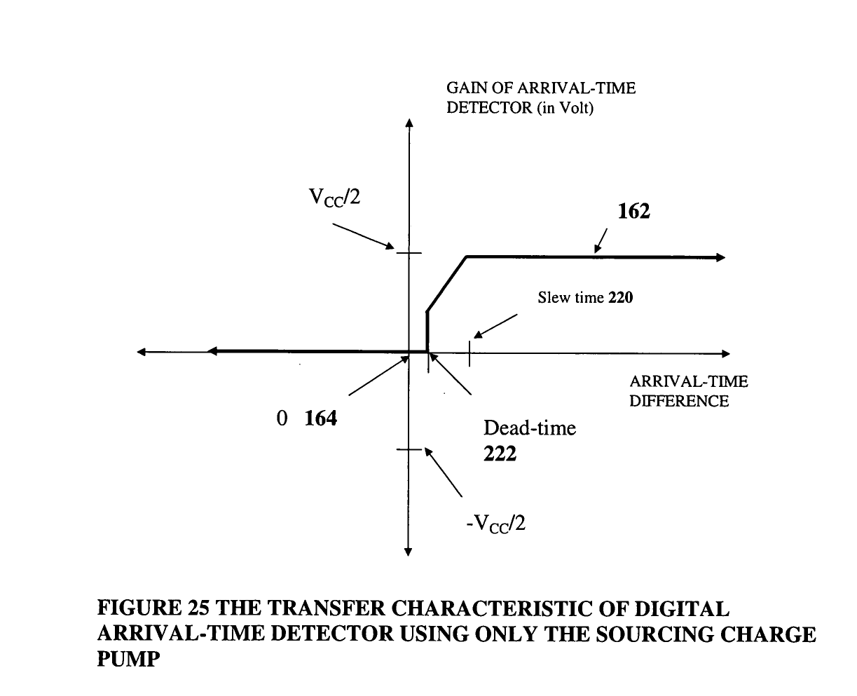

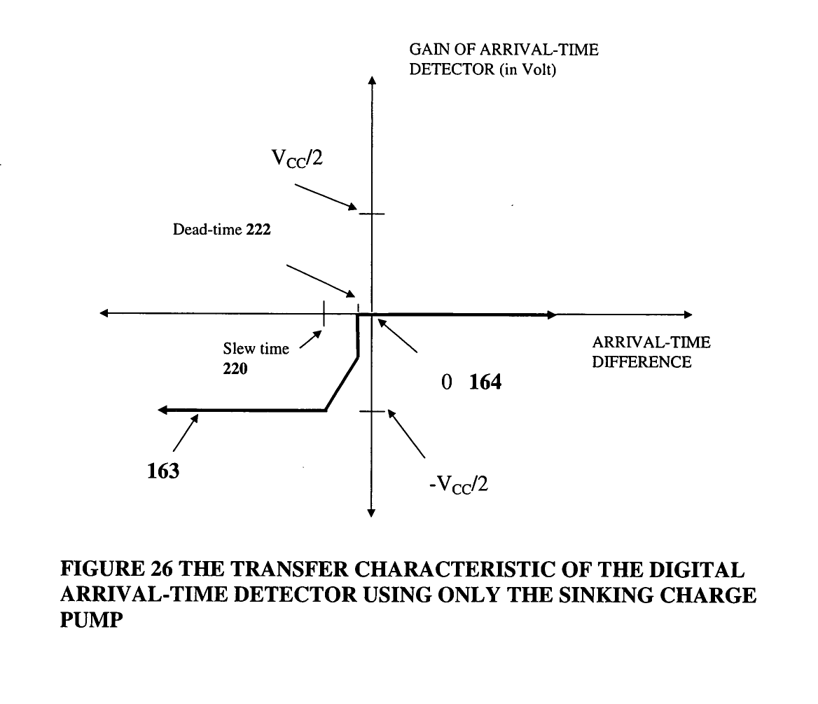

The transfer characteristics of the digital arrival-time detector 202 using only a sourcing charge pump output driver is shown in FIG. 25 and the transfer characteristics of the digital arrival-time detector 204 using only a sinking charge pump output driver is shown in FIG. 26. In these two designs, since the charge pump output drivers, 127 and 129, will be enabled for a duration exactly equal to arrival-time difference between two input signals that can range from 0 to infinity, the charge pump output drivers, 127 and 129, will not be able to produce any output until the arrival-time difference between the two input signals is long enough to overcome the input threshold of the charge pump output driver. As can be seen from these two figures, the charge pump output can not be fully turned on until the arrival-time difference between the two input signals is greater than the slew time 220 and the charge pump output will not produce any output at all until the arrival-time difference between the two input signals is greater than the dead-time 222. A dead zone is thus inevitable.

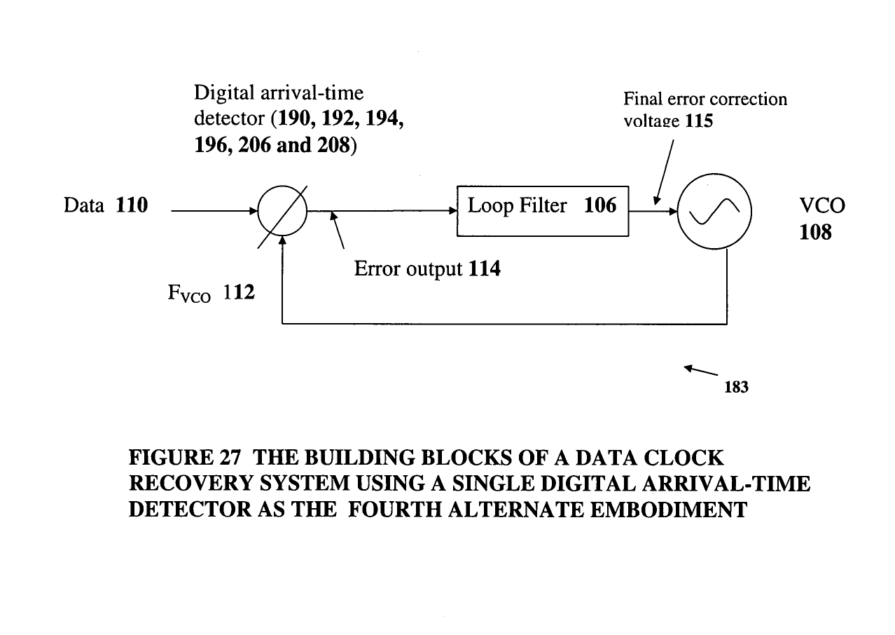

It is also possible to save half of the hardware by using either only the even arrival-time detector (190, 194 or 206) or only the odd arrival-time detector (192, 196 or 208) for a halved data clock recovery loop 183 as shown in FIG. 27; however, the halved data clock recovery loop 183 will respond slower because it can only track and correct the VCO for half of the time.

The designs as shown in FIG. 22 to 27 are presented as the alternative embodiments that use the minimum parts to produce the digital arrival-time detector and data clock recovery loop.

### INDUSTRIAL APPLICABILITY

In the field of consumer, industrial and military electronics, there is a significant demand for a fast and reliable data clock recovery circuit that is easy to build and has a large frequency capture range operating at the fastest possible data rate supported by the devices. All electronic products can all benefit significantly from this invention by producing lower cost products to the market in less time.

What is claimed:

1. An arrival-time locked loop, comprising:
an arrival-time detector having at least two input terminals and an output terminal, with a first of said at least two input terminals comprising a data input connectable to receive an incoming data stream from a communication channel, and wherein said output terminal of said arrival-time detector outputs an error output signal;
a loop filter having an input terminal and an output terminal and wherein said loop filter input terminal is connected to said output terminal of said arrival-time detector; and
a voltage controlled oscillator (VCO) having an input terminal and an output terminal, and wherein said VCO input terminal is connected to said output terminal of said loop-filter, and wherein said output terminal of said VCO is connected to a second of said at least two input terminals to said arrival-time detector.

2. The arrival-time locked loop of claim 1 wherein said error output signal is a positive signal if an arrival time of an arrival edge of said incoming data stream precedes an arrival time of an arrival edge of said VCO output signal, and wherein the arrival time of said VCO output signal is moved forward responsive to said positive signal.

3. The arrival-time locked loop of claim 2 wherein said error output signal is a negative signal if an arrival time of an arrival edge of said incoming data stream lags an arrival time of an arrival edge of said VCO output signal, and wherein the arrival time of said VCO output signal is moved backward responsive to said negative signal.

4. The arrival-time locked loop of claim 3, wherein said error output signal is zero if an arrival edge of said incoming data stream is absent.

5. The arrival-time locked loop of claim 4 wherein a magnitude of a VCO input signal derived from said positive signal is proportional to a time difference by which said arrival time of said incoming data stream precedes said arrival time of said VCO output signal.

6. The arrival-time locked loop of claim 5 wherein a magnitude of a VCO input signal derived from said negative signal is proportional to a time difference by which said arrival time of said incoming data stream lags said arrival time of said VCO output signal.

7. The arrival-time locked loop of claim 6 wherein said arrival-time detector comprises a normal phase-frequency detector (PFD), a complementary PFD, a polarity selection circuit and a charge pump.

8. The arrival-time locked loop of claim 7 wherein said polarity selection circuit comprises a first AND gate, a second AND gate, a first OR gate and a second OR gate, and wherein said charge pump is a double ended charge pump comprising a sourcing charge pump and a sinking charge pump.

9. The arrival-time locked loop of claim 8 wherein an output terminal of said normal PFD is connected to an input terminal of said first AND gate, an output terminal of said complementary PFD is connected to an input terminal of said first OR gate, an output terminal of said second AND gate is connected to an enabling terminal of said sourcing charge pump and an output terminal of said second OR gate is connected to an enabling terminal of said sinking charge pump.

10. The arrival-time locked loop of claim 7 wherein said polarity selection circuit comprises an AND gate and an OR gate, and wherein said charge pump is a double ended charge pump comprising a sourcing charge pump and a sinking charge pump.

11. A method for improving data clock recovery in a digital communication system, comprising:
receiving an incoming data stream from a communication channel;
generating an voltage controlled oscillator (VCO) output signal; and
comparing said received incoming data stream with said VCO output signal to generate an error output signal, whereby:
said error output signal is a positive signal if an arrival time of an arrival edge of said incoming data stream precedes an arrival time of an arrival edge of said VCO output signal, and wherein the arrival time of said VCO output signal is moved forward responsive to said positive signal.

12. The method of claim 11, wherein said error output signal is a negative signal if an arrival time of an arrival edge of said incoming data stream lags an arrival time of an arrival edge of said VCO output signal, and wherein the arrival time of said VCO output signal is moved backward responsive to said negative signal.

13. The method of claim 12, wherein said error output signal is zero if an arrival edge of said incoming data stream is absent.
